(19) United States
(12) Patent Application Publication
(10) Pub. No.: US 2006/0141395 A1
(43) Pub. Date: Jun. 29, 2006

(54) Metal complexes as light-absorbing compounds in the information layer of optical data carriers

(76) Inventors: Horst Berneth, Leverkusen (DE); Friedrich-Karl Bruder, Krefeld (DE); Rainer Hagen, Leverkusen (DE); Karin Hassenruck, Dusseldorf (DE); Serguei Kostromine, Swisttal-Buschhoven (DE); Christa Maria Kruger, Schneverdingen (DE); Timo Meyer-Friedrichsen, Krefeld (DE); Rafael Oser, Krefeld (DE); Josef-Walter Stawitz, Odenthal (DE)

Correspondence Address: Lanxess Corporation;Law and Intellectual Property Department, 100 Bayer Road, Pittsburgh, PA, 15205-9741, US

(21) Appl. No.: 10/522,476

(22) PCT Filed: Jul. 15, 2003
(86) PCT No.: PCT/EP03/07641

§ 371 Date: Oct. 4, 2005

(30) Foreign Application Priority Data
Jul. 26, 2002 (EP) 102 34 288.1

(51) Int. Cl. G11B 7/24; C07F 15/00

(52) U.S. Cl. 430/270.16; 534/707; 546/207

(57) ABSTRACT

Novel metal complexes for optical data carriers which comprise a preferably transparent substrate which may, if desired, have preivously been coated with one or more reflection layers and to whose surface a light-writable information layer, if desired one or more reflection layers and if desired a protective layer or a further substrate or a covering layer have been applied and which can be written on and read by means of blue or red light, preferably laser light, where the information layer comprises a light-absorbent compound and, if desired, a binder, characterized in that at least one such metal complex is used as light-absorbent compound, have been found.

The invention relates to metal complexes, to a process for preparing them, to the azo compounds functioning as ligands in the metal complexes and their preparation, to the coupling components on which the azo compounds are based and their preparation and to optical data stores whose information layer comprises the metal complexes.

Write-once optical data carriers using specific light-absorbent substances or mixtures thereof are particularly suitable for use in high-density writable optical data stores which operate with blue laser diodes, in particular GaN or SHG laser diodes (360-460 nm) and/or for use in DVD-R or CD-R disks which operate with red (635-660 nm) or infrared (780-830 nm) laser diodes.

The write-once compact disc (CD-R, 780 nm) has recently experienced enormous volume growth and represents the technically established system.

The next generation of optical data stores—DVDs—is currently being introduced onto the market. Through the use of shorter-wavelength laser radiation (635-660 nm) and higher numerical aperture NA, the storage density can be increased. The writable format in this case is DVD-R.

Today, optical data storage formats which use blue laser diodes (based on GaN, JP 08191171 or Second Harmonic Generation SHG JP 09050629) (360 nm-460 nm) with high laser power are being developed. Writable optical data stores will therefore also be used in this generation. The achievable storage density depends on the focusing of the laser spot in the information plane. Spot size scales with the laser wavelength λ/NA. NA is the numerical aperture of the objective lens used. In order to obtain the highest possible storage density, the use of the smallest possible wavelength λ is the aim. At present 390 nm is possible on the basis of semiconductor laser diodes.

The patent literature describes dye-based writable optical data stores which are equally suitable for CD-R and DVD-R systems (JP-A 11 043 481 and JP-A 10 181 206). To achieve a high reflectivity and a high modulation height of the read-out signal and also to achieve sufficient sensitivity in writing, use is made of the fact that the IR wavelength of 780 nm of CD-Rs is located at the foot of the long wavelength flank of the absorption peak of the dye and the red wavelength of 635 nm or 650 nm of DVD-Rs is located at the foot of the short wavelength flank of the absorption peak of the dye. In JP-A 02 557 335, JP-A 10 058 828, JP-A 06 336 086, JP-A 02 865 955, WO-A 09 917 284 and U.S. Pat. No. 5,266,699, this concept is extended to the 450 nm working wavelength region on the short wavelength flank and the red and IR region on the long wavelength flank of the absorption peak.

Apart from the abovementioned optical properties, the writable information layer comprising light-absorbent organic substances has to have a substantially amorphous morphology to keep the noise signal during writing or reading as small as possible. For this reason, it is particularly preferred that crystallization of the light-absorbent substances be prevented in the application of the substances by spin coating from a solution, by vapour deposition and/or sublimation during subsequent covering with metallic or dielectric layers under reduced pressure.

The amorphous layer comprising light-absorbent substances preferably has a high heat distortion resistance, since otherwise further layers of organic or inorganic material which are applied to the light-absorbent information layer by sputtering or vapour deposition would form blurred boundaries due to diffusion and thus adversely affect the reflectivity. Furthermore, a light-absorbent substance which has insufficient heat distortion resistance can, at the boundary to a polymeric support, diffuse into the latter and once again adversely affect the reflectivity.

A light-absorbent substance whose vapour pressure is too high can sublime during the abovementioned deposition of further layers by sputtering or vapour deposition in a high vacuum and thus reduce the layer thickness to below the desired value. This in turn has an adverse effect on the reflectivity.

It is therefore an object of the invention to provide suitable compounds which satisfy the demanding requirements (e.g. light stability, favourable signal/noise ratio, damage-free application to the substrate material, and the like) for use in the information layer in a write-once optical data carrier, in particular for high-density writable optical data store formats in a laser wavelength range from 340 to 680 nm.

Surprisingly, it has been found that light-absorbent compounds selected from the group of specific metal complexes can satisfy the abovementioned requirement profile particularly well.

The invention accordingly provides metal complexes which have at least one ligand of the formula I 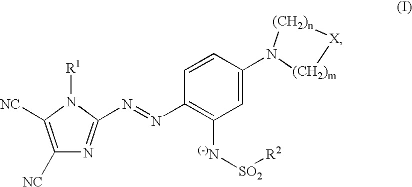
where
R¹ is hydrogen, substituted or unsubstituted C₁-C₆-alkyl or substituted or unsubstituted C₇-C₁₂-aralkyl,
R² is substituted or unsubstituted C₁-C₆-alkyl,
X is O, NH, NR³, CH₂ or a direct bond,
R³ is substituted or unsubstituted C₁-C₆-alkyl and
m and n are each, independently of one another, 1, 2 or 3,
   and metal complexes which have at least one of the ligands of the formula (LI) 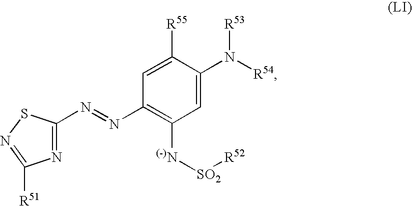
   where
R⁵¹ is substituted or unsubstituted C₆-C₁₀-aryl, in particular phenyl, a substituted or unsubstituted 5- or 6-membered heterocyclic radical, in particular pyridyl, C₁-C₆-alkylthio, C₇-C₁₀-aralkylthio, substituted or unsubstituted C₆-C₁₀-arylthio, in particular phenylthio, C₁-C₆-alkylsulphonyl, C₇-C₁₀-aralkyl-sulphonyl or substituted or unsubstituted C₆-C₁₀-arylsulphonyl, in particular phenylsulphonyl,
R⁵² is substituted or unsubstituted C₁-C₆-alkyl, in particular C₁-C₆-alkyl or perfluoro-C₁-C₆-alkyl,
R⁵³ and R⁵⁴ are each, independently of one another, substituted or unsubstituted C₁-C₆-alkyl, substituted or unsubstituted C₇-C₁₀-aralkyl or substituted or unsubstituted C₆-C₁₀-aryl or
NR⁵³R⁵⁴ is pyrrolidino, piperidino, morpholino, piperazino or N—C₁-C₆-alkyl-piperidino,
R⁵⁵ is hydrogen, methyl or methoxy or
R⁵³; R⁵⁵ together form a —(CH₂)₂—, —(CH₂)₃— or —(CH₂)₂—O— bridge,
   and metal complexes which have at least one ligand of the formula (CI) 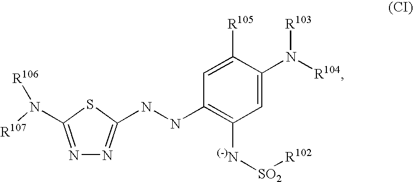
   where
R¹⁰² is substituted or unsubstituted C₁-C₆-alkyl, in particular C₁-C₆-alkyl or perfluoro-C₁-C₆-alkyl,
R¹⁰³, R¹⁰⁴, R¹⁰⁶ and R¹⁰⁷ are each, independently of one another, substituted or unsubstituted C₁-C₆-alkyl, substituted or unsubstituted C₇-C₁₀-aralkyl or substituted or unsubstituted C₆-C₁₀-aryl or
NR¹⁰³R¹⁰⁴ and NR¹⁰⁶R¹⁰⁷ are each, independently of one another, pyrrolidino, piperidino, morpholino, piperazino or N—C₁-C₆-alkyl-piperidino,
R¹⁰⁵ is hydrogen, methyl or methoxy or
R¹⁰³; R¹⁰⁵ together form a —(CH₂)₂—, —(CH₂)₃— or —(CH₂)₂—O— bridge.

In a preferred embodiment, the metal complexes are in the form of 1:1 or 1:2 metal:azo complexes.

Metal complexes containing two identical or different ligands of the formulae I, LI and CI are distinctly preferred.

Preference is given to metal complexes which are characterized in that they have the formula (Ia)
[(I)]₂⁻M²⁺ (Ia)
where the two ligands of the formula (I) are each, independently of one another, as defined above and
M is a metal.

Preference is likewise given to metal complexes which are characterized in that they have the formula (LIa)
[(LI)]₂⁻M²⁺ (LIa)
where the two ligands of the formula (LIa) are each, independently of one another, as defined above and
M is a metal.

Preference is likewise given to metal complexes which are characterized in that they have the formula (CIa)
[(CI)]₂⁻M²⁺ (CIa)
where the two ligands of the formula (CI) are each, independently of one another, as defined above and
M is a metal.

Preference is likewise given to random mixtures of metal complexes which are characterized in that they contain two different ligands of the formulae I, (LI) and/or (CI).

Preferred metals are divalent metals, transition metals or rare earths, in particular Mg, Ca, Sr, Ba, Cu, Ni, Co, Fe, Zn, Pd, Pt, Ru, Th, Os, Sm. Preference is given to the metals Pb, Fe, Zn, Cu, Ni and Co. Particular preference is given to Ni and Zn.

Possible substituents on the alkyl or aralkyl radicals are halogen, in particular Cl or F, nitro, cyano, CO—NH₂, alkoxy, trialkylsilyl and trialkylsiloxy. The alkyl radicals can be linear or branched and may be partially halogenated or perhalogenated. Examples of substituted alkyl radicals are trifluoromethyl, chloroethyl, cyanoethyl, methoxyethyl. Examples of branched alkyl radicals are isopropyl, tert-butyl, 2-butyl, neopentyl.

Preferred substituted or unsubstituted C₁-C₆-alkyl radicals are methyl, ethyl, n-propyl, isopropyl, n-butyl, 2-butyl, iso-butyl, tert-butyl, n-pentyl, n-hexyl, perfluorinated methyl, perfluorinated ethyl, 3,3,3-trifluoroethyl, perfluorobutyl, cyanoethyl, methoxyethyl.

Examples of preferred aralkyl groups are benzyl, phenethyl and phenylpropyl.

The metal complexes of the formula Ia presumably have the formula II 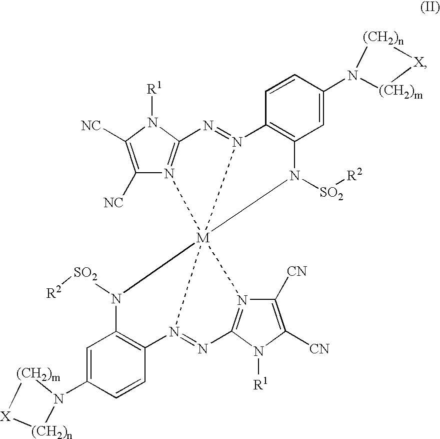
where M and the radicals of the respective azo ligands are each, independently of one another, as defined above. For the purposes of the present patent application, it is assumed that the formulae II and Ia characterize the same compounds.

Particular preference is given to metal complexes of the formula I, in particular Ia, in which
R¹ is methyl, ethyl, propyl, butyl, cyanoethyl, methoxyethyl or benzyl,
R² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
X is O, CH₂ or a direct bond,
m and n are each, independently of one another, 1 or 2, and
M is Pd, Fe, Zn, Cu, Ni or Co.

Greater preference is given to metal complexes of the formula I, in particular Ia, in which
R¹ is methyl or ethyl, in particular methyl,
R² is methyl or trifluoromethyl, in particular trifluoromethyl,
X is CH₂ or a direct bond,
m and n are each 2, and
M is Zn, Cu, Ni or Co.

Metal complexes of the formula I, in particular Ia, which correspond to the formulae III and IV 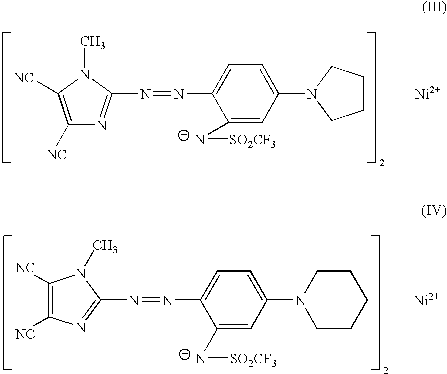
are regarded as having particularly outstanding utility.

The metal complexes of the formula LIa presumably have the formula LII 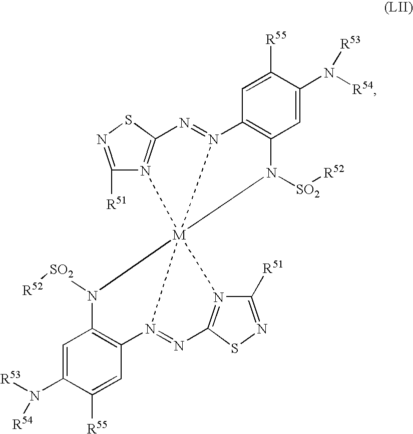
where M and the radicals of the respective azo ligands are each, independently of one another, as defined above. For the purposes of the present patent application, it is assumed that the formulae LII and LIa characterize the same compounds.

Particular preference is given to metal complexes having ligands of the formula LI, in particular metal complexes of the formula LIa,

in which

R⁵¹ is phenyl, pyridyl, methylthio, ethylthio, propylthio, benzylthio, methyl-sulphonyl, benzylsulphonyl or phenylsulphonyl,
R⁵² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
R⁵³ and R⁵⁴ are each, independently of one another, methyl, ethyl, propyl, butyl, cyanoethyl, chloroethyl, methoxyethyl, benzyl, phenethyl or phenyl or
NR⁵³R⁵⁴ is pyrrolidino, piperidino or morpholino,
R⁵⁵ is hydrogen and
M is Pd, Fe, Zn, Cu, Ni or Co,
   where the propyl or butyl radicals may also be branched.

Very particular preference is given to metal complexes having ligands of the formula (LI), in particular metal complexes of the formula (LIa),

in which

R⁵¹ is phenyl,
R⁵² is methyl or trifluoromethyl, preferably trifluoromethyl,
R⁵³ and R⁵⁴ are each, independently of one another, methyl, ethyl, cyanoethyl or benzyl or
NR⁵³R⁵⁴ is pyrrolidino or piperidino,
R⁵⁵ is hydrogen and
M is Zn, Cu, Ni or Co,
   where the propyl or butyl radicals may also be branched.

The metal complexes of the formula (LIa) which correspond to the formula (LIII) 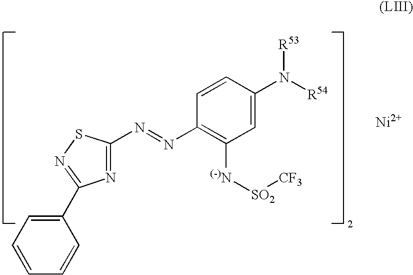
where
R⁵³ is methyl or ethyl,
R⁵⁴ is methyl, ethyl or cyanoethyl or
NR⁵³R⁵³ is pyrrolidino or piperidino,
   are regarded as having particularly outstanding utility.

The metal complexes of the formula CIa presumably have the formula CII 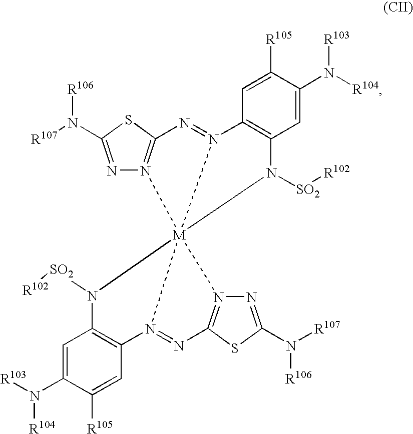
where M and the radicals of the respective azo ligands are each, independently of one another, as defined above. For the purposes of the present application, it is assumed that the formulae CII and CIa characterize the same compounds.

Particular preference is given to metal complexes having ligands of the formula CI, in particular metal complexes of the formula CIa,

in which

R¹⁰⁶ and R¹⁰⁷ are each, independently of one another, methyl, ethyl, propyl, butyl, cyanoethyl, chloroethyl, methoxyethyl, benzyl, phenethyl or phenyl or
NR¹⁰⁶R¹⁰⁷ is pyrrolidino, piperidino or morpholino,
R¹⁰² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
R¹⁰³ and R¹⁰⁴ are each, independently of one another, methyl, ethyl, propyl, butyl, cyanoethyl, chloroethyl, methoxyethyl, benzyl, phenethyl or phenyl or
NR¹⁰³R¹⁰⁴ is pyrrolidino, piperidino or morpholino,
R¹⁰⁵ is hydrogen and
M is Pd, Fe, Zn, Cu, Ni or Co,
   where the propyl or butyl radicals may also be branched.

Very particular preference is given to metal complexes having ligands of the formula CI, in particular metal complexes of the formula (CIa), in which
NR¹⁰⁶R¹⁰⁷ is dimethylamino, diethylamino, dipropylamino, N-cyanoethyl-N-methylamino, N-cyanoethyl-N-ethylamino, N,N-dicyanoethylamino, pyrrolidino or piperidino,
R¹⁰² is methyl or trifluoromethyl, preferably trifluoromethyl,
R¹⁰³ and R¹⁰⁴ are each, independently of one another, methyl, ethyl, cyanoethyl or benzyl or
NR¹⁰³R¹⁰⁴ is pyrrolidino or piperidino,
R¹⁰⁵ is hydrogen and
M is Zn, Cu, Ni or Co,
   where the propyl or butyl radicals may also be branched.

The metal complexes of the formula (CIa) which correspond to the formula (CIII) 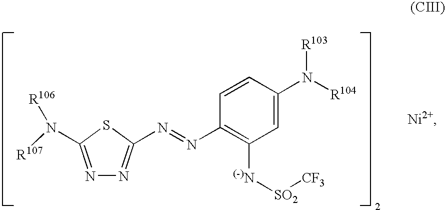
where
NR¹⁰⁶R¹⁰⁷ is dimethylamino, diisopropylamino or pyrrolidino,
R¹⁰³ is methyl or ethyl,
R¹⁰⁴ is methyl, ethyl or cyanoethyl or
NR¹⁰³R¹⁰⁴ is pyrrolidino or piperidino,
   are regarded as having particularly outstanding utility.

The metal complexes of the invention are, in particular, used commercially as powder or in granular form or as a solution having a solids content of at least 2% by weight. Preference is given to the granular form, in particular granular materials having mean particle sizes of from 50 μm to 10 mm, in particular from 100 to 800 μm. Such granular materials can be produced, for example, by spray drying. The granular materials are particularly low in dust.

Preference is likewise given to concentrated solutions. They contain at least 2 percent by weight, preferably at least 5 percent by weight, of the metal complexes of the invention, particularly those of the formulae Ia, III, IV (CIa), (LIa), LIII and CIII. As solvent, preference is given to using 2,2,3,3-tetrafluoropropanol, propanol, butanol, pentanol, diacetone alcohol, dibutyl ether, heptanone or mixtures thereof. Particular preference is given to 2,2,3,3-tetrafluoropropanol.

The invention further provides a process for preparing the metal complexes of the invention, which is characterized in that a metal salt is reacted with an azo compound of the formula (Ib) 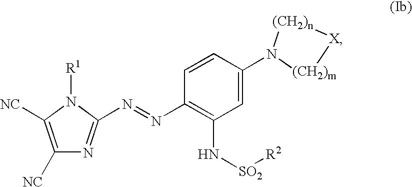
where
R¹ is hydrogen, substituted or unsubstituted C₁-C₆-alkyl or substituted or unsubstituted C₇-C₁₂-aralkyl,
R² is substituted or unsubstituted C₁-C₆-alkyl,
X is O, NH, NR³, CH₂ or a direct bond,
R³ is substituted or unsubstituted C₁-C₆-alkyl and
m and n are each, independently of one another, 1, 2 or 3.

In this process according to the invention, it is also possible to use two or more different azo compounds of the formula Ib. This then gives a random mixture of metal complexes consisting of complexes containing two identical ligands of the formula I and complexes which contain two different ligands of the formula I. These mixtures are likewise subject-matter of the invention.

The invention further provides a process for preparing the metal complexes of the invention, which is characterized in that a metal salt is reacted with an azo compound of the formula (Lib) 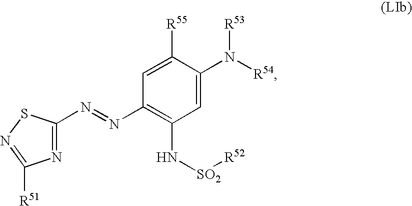
where the radicals R⁵¹-R⁵⁵ are as defined above.

In this process according to the invention, it is also possible to use two or more different azo compounds of the formula (LIb). This then gives a random mixture of metal complexes consisting of complexes containing two identical ligands of the formula (LI) and complexes which contain two different ligands of the formula (LI). These mixtures are likewise subject-matter of the invention.

The invention further provides a process for preparing the metal complexes of the invention, which is characterized in that a metal salt is reacted with an azo compound of the formula (CIb) 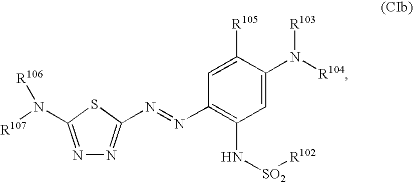
where the radicals R¹⁰²-R¹⁰⁵ are as defined above.

In this process according to the invention, it is also possible to use two or more different azo compounds of the formula CIb. This then gives a random mixture of metal complexes consisting of complexes containing two identical ligands of the formula CI and complexes which contain two different ligands of the formula CI. These mixtures are likewise subject-matter of the invention.

The preparation of metal complexes and the metal complexes themselves are completely analogous if the preparation of the complexes is carried out using a mixture of azo compounds of the formulae Ib, LIb and/or CIb.

The reaction according to the invention is generally carried out in a solvent or solvent mixture, in the presence or absence of basic substances, at from room temperature to the boiling point of the solvent, for example 20-100° C., preferably 20-50° C. The metal complexes either precipitate directly and can be isolated by filtration or they are precipitated by, for example, addition of water, possibly with prior removal or partial removal of the solvent, and isolated by filtration. It is also possible to carry out the reaction directly in the solvent to give the abovementioned concentrated solutions.

For the purposes of the present invention, metal salts are, for example, the chlorides, bromides, sulphates, hydrogensulphates, phosphates, hydrogenphosphates, dihydrogenphosphates, hydroxides, oxides, carbonates, hydrogencarbonates, carboxylates such as formates, acetates, propionates, benzoates, sulphonates such as methanesulphonates, trifluoromethanesulphonates or benzenesulphonates of the corresponding metals. The term metal salts likewise encompasses complexes containing ligands other than those of the formulae (Ia), (LIa) and (CIa), in particular complexes of acetylacetone and ethyl acetoacetate. Examples of possible metal salts are: nickel acetate, cobalt acetate, copper acetate, nickel chloride, nickel sulphate, cobalt chloride, copper chloride, coppe sulphate, nickel hydroxide, nickel oxide, nickel acetylacetonate, cobalt hydroxide, basic copper carbonate, barium chloride, iron sulphate, palladium acetate, palladium chloride and the variants thereof containing water of crystallization.

Possible basic substances are alkali metal acetates such as sodium acetate, potassium acetate, alkali metal hydrogencarbonates, alkali metal carbonates or alkali metal hydroxides, e.g. sodium hydrogencarbonate, potassium carbonate, lithium hydroxide, sodium hydroxide, or amines such as ammonia, dimethylamine, triethylamine, diethanolamine. Such basic substances are particularly advantageous when metal salts of strong acids, e.g. metal chlorides or sulphates, are used.

Suitable solvents are water, alcohols such as methanol, ethanol, propanol, butanol, 2,2,3,3-tetrafluoropropanol, ethers such as dibutyl ether, dioxane or tetrahydrofuran, aprotic solvents such as dimethylformamide, N-methylpyrrolidone, acetonitrile, nitromethane, dimethyl sulphoxide. Preference is given to methanol, ethanol and 2,2,3,3-tetrafluoropropanol.

The azo compounds of the formulae (Ib), (LIb) and (CIb) required for preparing the metal complexes of the invention are likewise subject-matter of the present invention.

The invention therefore also provides azo compounds of the formula (Ib) 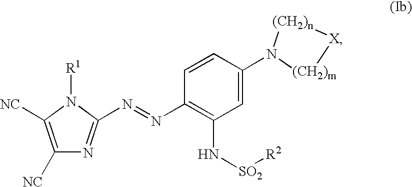
where
R¹ is hydrogen, substituted or unsubstituted C₁-C₆-alkyl or substituted or unsubstituted C₇-C₁₂-aralkyl,
R² is substituted or unsubstituted C₁-C₆-alkyl,
X is O, NH, NR³, CH₂ or a direct bond,
R³ is substituted or unsubstituted C₁-C₆-alkyl and
m and n are each, independently of one another, 1, 2 or 3.

Particular preference is given to azo compounds of the formula Ib in which
R¹ is methyl, ethyl, propyl, butyl, cyanoethyl, methoxyethyl or benzyl,
R² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
X is O, CH₂ or a direct bond,
m and n are each, independently of one another, 1 or 2, in particular
R¹ is methyl or ethyl, in particular methyl,
R² is methyl or trifluoromethyl, in particular trifluoromethyl,
X is CH₂ or a direct bond,
m and n are each 2.

Very particular preference is given to azo compounds of the formula Ib which correspond to the formulae V and VI.

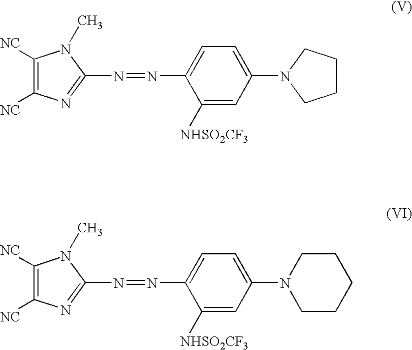

The invention therefore also provides azo compounds of the formula (LIb) 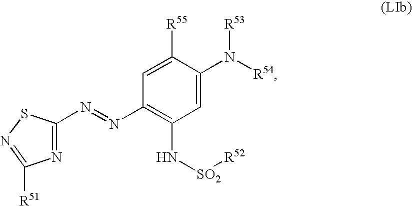
where
R⁵¹-R⁵⁵ are as defined above.

Preference is given to azo compounds of the formula (LIb) in which
R⁵¹ is phenyl, pyridyl, methylthio, ethylthio, propylthio, benzylthio, methyl-sulphonyl, benzylsulphonyl or phenylsulphonyl,
R⁵² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl, preferably difluoromethyl, 3,3-difluoroethyl, 3,3,3-trifluoroethyl, trifluoromethyl, pentafluoroethyl, heptafluoropropyl or perfluorobutyl,
R⁵³ and R⁵⁴ are each, independently of one another, methyl, ethyl, propyl, butyl, cyanoethyl, chloroethyl, methoxyethyl, benzyl, phenethyl or phenyl or
NR⁵³R⁵⁴ is pyrrolidino, piperidino or morpholino,
R⁵⁵ is hydrogen,
   where the propyl or butyl radicals may also be branched.

Particular preference is given to azo compounds of the formula (LIb) in which
R⁵¹ is phenyl,
R⁵² is methyl or trifluoromethyl, preferably trifluoromethyl,
R⁵³ and R⁵⁴ are each, independently of one another, methyl, ethyl, cyanoethyl or benzyl or
NR⁵³R⁵⁴ is pyrrolidino or piperidino,
R⁵⁵ is hydrogen.

Very particular preference is given to azo compounds of the formula (LV) 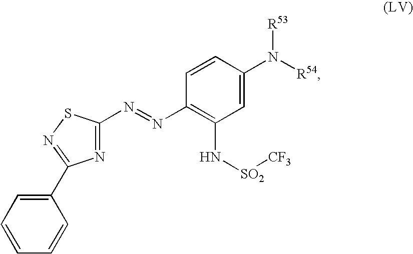
where
R⁵³ is methyl or ethyl,
R⁵⁴ is methyl, ethyl or cyanoethyl or
NR⁵³R⁵⁴ is pyrrolidino or piperidino.

Some of the azo compounds of the formula (CIb) are known, e.g. from U.S. Pat. No. 5,208,325.

The invention therefore also provides azo compounds of the formula (CIb) 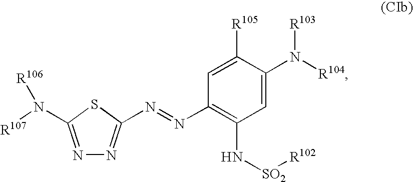
in which
R¹⁰² is perfluoro-C₁-C₆-alkyl,
R¹⁰³, R¹⁰⁴, R¹⁰⁶ and R¹⁰⁷ are each, independently of one another, substituted or unsubstituted C₁-C₆-alkyl, substituted or unsubstituted C₇-C₁₀-aralkyl or substituted or unsubstituted C₆-C₁₀-aryl or
NR¹⁰³R¹⁰⁴ and NR¹⁰⁶R¹⁰⁷ are each, independently of one another, pyrrolidino, piperidino, morpholino, piperazino or N—C₁-C₆-alkyl-piperidino,
R¹⁰⁵ is hydrogen, methyl or methoxy or
R¹⁰³; R¹⁰⁵ together form a —(CH₂)₂—, —(CH₂)₃— or —(CH₂)₂—O— bridge.

Preference is given to azo compounds of the formula (CIb) in which
R¹⁰² is difluoromethyl, 3,3-difluoroethyl, 3,3,3-trifluoroethyl, trifluoromethyl, pentafluoroethyl, heptafluoropropyl or perfluorobutyl,
R¹⁰⁶ and R¹⁰⁷ are each, independently of one another, methyl, ethyl, propyl, butyl, cyanoethyl, chloroethyl, methoxyethyl, benzyl, phenethyl or phenyl or
NR¹⁰⁶R¹⁰⁷ is pyrrolidino, piperidino or morpholino,
R¹⁰³ and R¹⁰⁴ are each, independently of one another, methyl, ethyl, propyl, butyl, cyanoethyl, chloroethyl, methoxyethyl, benzyl, phenethyl or phenyl or
NR¹⁰³R¹⁰⁴ is pyrrolidino, piperidino or morpholino,
R¹⁰⁵ is hydrogen.

Particular preference is given to azo compounds of the the formula (CIb) in which
NR¹⁰⁶R¹⁰⁷ is dimethylamino, diethylamino, dipropylamino, N-cyanoethyl-N-methylamino, N-cyanoethyl-N-ethylamino, N,N-dicyanoethylamino, pyrrolidino or piperidino,
R¹⁰² is trifluoromethyl,
R¹⁰³ and R¹⁰⁴ are each, independently of one another, methyl, ethyl, cyanoethyl or benzyl or
NR¹⁰³R¹⁰⁴ is pyrrolidino or piperidino,
R¹⁰⁵ is hydrogen,
   where the propyl or butyl radicals may also be branched.

Very particular preference is given to azo compounds of the formula (CIb) which correspond to the formula (CV) 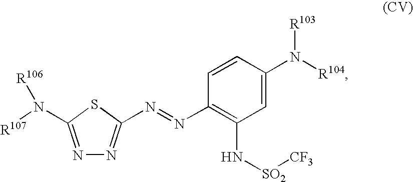
where
NR¹⁰⁶R¹⁰⁷ is dimethylamino, diisopropylamino or pyrrolidino,
R¹⁰³ is methyl or ethyl,
R¹⁰⁴ is methyl, ethyl or cyanoethyl or
NR¹⁰³R¹⁰⁴ is pyrrolidino or piperidino.

The invention likewise provides a process for preparing the novel azo compounds of the formula (Ib), which is characterized in that an aminoimidazole of the formula (VII) 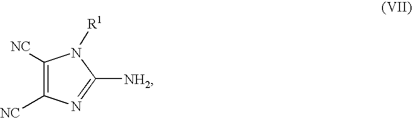
where
R¹ is hydrogen, substituted or unsubstituted C₁-C₆-alkyl or substituted or unsubstituted C₇-C₁₂-aralkyl,
   is diazotized and coupled with a coupling component of the formula VIII 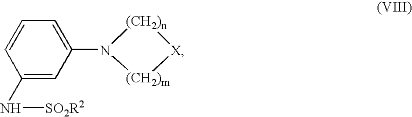
   where
R² is substituted or unsubstituted C₁-C₆-alkyl,
X is O, NH, NR³, CH₂ or a direct bond,
R³ is substituted or unsubstituted C₁-C₆-alkyl and
m and n are each, independently of one another, 1, 2 or 3.

The invention also provides a process for preparing the novel azo compounds of the formula Ib, which is characterized in that an aminoimidazole of the formula (IX) 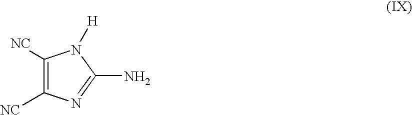
is diazotized, coupled with a coupling component of the formula VIII 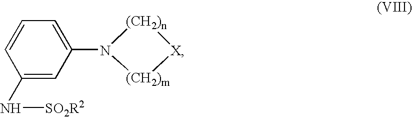
where
R² is substituted or unsubstituted C₁-C₆-alkyl,
X is O, NH, NR³, CH₂ or a direct bond,
R³ is substituted or unsubstituted C₁-C₆-alkyl and
m and n are each, independently of one another, 1, 2 or 3,
   and subsequently reacted with an alkylating agent of the formula
   R¹—Y (X),
   where
R¹ is hydrogen, substituted or unsubstituted C₁-C₆-alkyl or substituted or unsubstituted C₇-C₁₂-aralkyl and
Y is a leaving group,
   preferably in the presence of a basic substance.

R¹—Y is preferably an alkyl or aralkyl chloride, bromide, iodide, methanesulphonate, trifluoromethanesulphonate, benzenesulphonate, toluenesulphonate or an alkyl or aralkyl sulphate. Examples are methyl iodide, benzyl bromide, dimethyl sulphate, ethyl toluenesulphonate.

As basic substances, the basic substances mentioned above are suitable.

The invention also provides a process for preparing the novel azo compounds of the formula Lib, which is characterized in that a 5-amino-1,2,4-thiadiazole of the formula (LVII) 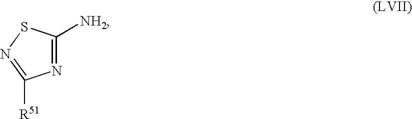
where
R⁵¹ is substituted or unsubstituted C₆-C₁₀-aryl, in particular phenyl, a substituted or unsubstituted 5- or 6-membered heterocyclic radical, in particular pyridyl, substituted or unsubstituted C₁-C₆-alkylthio, substituted or unsubstituted C₇-C₁₀-aralkylthio or substituted or unsubstituted C₆-C₁₀-arylthio or phenylthio,
   is diazotized or nitrosated and coupled with a coupling component of the formula LVIII 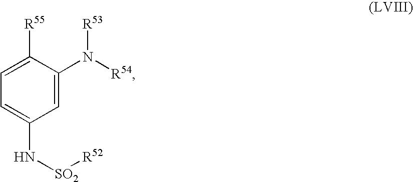
   where
R⁵² is substituted or unsubstituted C₁-C₆-alkyl,
R⁵³ and R⁵⁴ are each, independently of one another, substituted or unsubstituted C₁-C₆-alkyl, substituted or unsubstituted C₇-C₁₀-aralkyl or substituted or unsubstituted C₆-C₁₀-aryl or
NR⁵³R⁵⁴ is pyrrolidino, piperidino, morpholino, piperazino or N—C₁-C₆-alkyl-piperidino,
R⁵⁵ is hydrogen, methyl or methoxy or
R⁵³; R⁵⁵ together form a —(CH₂)₂—, —(CH₂)₃— or —(CH₂)₂—O— bridge.

The invention also provides a process for preparing the novel azo compounds of the formula CIb, which is characterized in that a 2-amino-1,3,4-thiadiazole of the formula (CVII) 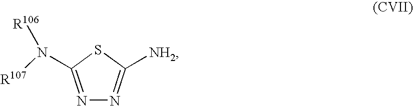
where
R¹⁰⁶ and R¹⁰⁷ are each, independently of one another, substituted or unsubstituted C₁-C₆-alkyl, substituted or unsubstituted C₇-C₁₀-aralkyl or substituted or unsubstituted C₆-C₁₀-aryl or
NR¹⁰⁶R¹⁰⁷ is pyrrolidino, piperidino, morpholino, piperazino or N—C₁-C₆-alkyl-piperidino,
   is diazotized and coupled with a coupling component of the formula LVIII 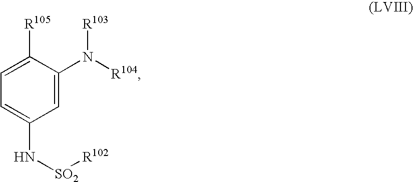
   where
R¹⁰² is substituted or unsubstituted C₁-C₆-alkyl,
R¹⁰³ and R¹⁰⁴ are each, independently of one another, substituted or unsubstituted C₁-C₆-alkyl, substituted or unsubstituted C₇-C₁₀-aralkyl or substituted or unsubstituted C₆-C₁₀-aryl or
NR¹⁰³R¹⁰⁴ is pyrrolidino, piperidino, morpholino, piperazino or N—C₁-C₆-alkyl-piperidino,
R¹⁰⁵ is hydrogen, methyl or methoxy or
R¹⁰³; R¹⁰⁵ together form a —(CH₂)₂—, —(CH₂)₃— or —(CH₂)₂—O— bridge.

Diazotizations, nitrosations and couplings are known per se from the literature, e.g. from Chem. Ber. 1958, 91, 1025; Chem. Ber. 1961, 94, 2043; U.S. Pat. No. 5,208,325. The methods described there can be employed in an analogous manner.

The aminoimidazoles of the formulae VII and X to be used in the process of the invention are known, for example, from J. Polym. Sci.: Part A: Polym. Chem. 1993, 31, 351, or can be prepared in an analogous manner.

The 5-amino-1,2,4-thiadiazoles of the formula LVII to be used in the processes of the invention are known, for example, from Chem. Ber. 1954, 87, 68; Chem. Ber. 1956, 89, 1956, 2742; DE-A 2 811 258, or can be prepared in an analogous manner.

The invention further provides the coupling component of the formula (VIII) 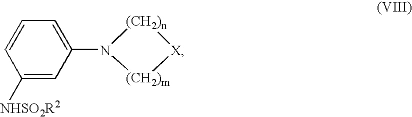
where
R² is substituted or unsubstituted C₁-C₆-alkyl,
X is O, NH, NR³, CH₂ or a direct bond,
R³ is substituted or unsubstituted C₁-C₆-alkyl and
n and m are each, independently of one another, 1, 2 or 3.

The invention likewise provides a process for preparing coupling components of the formula VIII, which is characterized in that
3-nitroaniline is reacted with a bifunctional alkylating agent of the formula 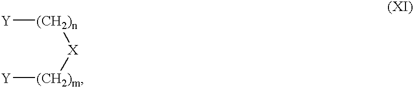
where
X is O, NH, NR³, CH₂ or a direct bond,
Y is a leaving group and
n and m are each, independently of one another, 1, 2 or 3,
   to form a nitro compound of the formula 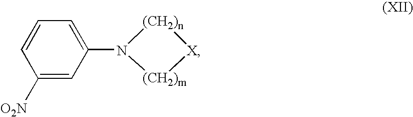
   where
X is O, NH, NR³, CH₂ or a direct bond and
n and m are each, independently of one another, 1, 2 or 3,
   the nitro compound of the formula (XII) is hydrogenated to form the amino compound of the formula 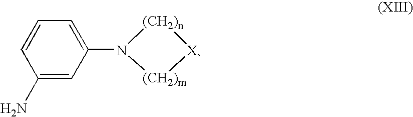
   where
X is O, NH, NR³, CH₂ or a direct bond and
n and m are each, independently of one another, 1, 2 or 3,
   and the amino compound of the formula (XIII) is reacted with
   an acid chloride or anhydride of the formula 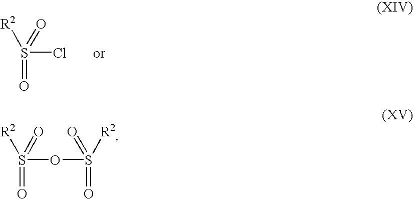
   where
R² is substituted or unsubstituted C₁-C₆-alkyl.

This gives the coupling component of the formula (VIII) in free form, as HCl salt or as R²SO₂OH salt.

Alkylating agents of the formula (XI) are, for example, 1,4-dibromobutane, 1,5-di-bromopentane, bis(2-chloroethyl) ether, 1,4-bis(benzenesulphonyloxy)butane.

Compounds of the formula (XII) are known, for example, from Chem. Pharm. Bull., 1998, 46, 951. However, they can also be prepared by a method analogous to that reported in Bull. Chem. Soc. Jpn., 1991, 64, 42.

The coupling components of the formulae (LVIII) and (CVIII) are known, for example, from U.S. Pat. No. 6,225,023 or can be prepared in an analogous manner.

The invention further provides for the use of the metal complexes of the invention as light-absorbent compounds in the information layer of write-once optical data carriers.

In this use, the optical data carrier is preferably written on and read by means of blue laser light, in particular laser light having a wavelength in the range 360-460 nm.

Preference is likewise given in this use to the optical data carrier being written on and read by means of red laser light, in particular laser light having a wavelength in the range 600-700 nm.

The invention further provides for the use of metal complexes having azo ligands as light-absorbent compound in the information layer of write-once optical data carriers which can be written on and read by means of blue laser light, in particular laser light having a wavelength in the range 360-460 nm.

The invention further provides an optical data carrier comprising a preferably transparent substrate which may, if desired, have previously been coated with one or more reflection layers and to whose surface a light-writable information layer, if desired one or more reflection layers and if desired a protective layer or a further substrate or a covering layer have been applied, which can be written on and read by means of blue light, preferably light having a wavelength in the range 360-460 nm, in particular from 390 to 420 nm, very particularly preferably from 400 to 410 nm, or red light, preferably light having a wavelength in the range 600-700 nm, preferably from 620 to 680 nm, very particularly preferably from 630 to 660 nm, preferably laser light, where the information layer comprises a light-absorbent compound and, if desired, a binder, characterized in that at least one metal complex according to the invention is used as light-absorbent compound.

The light-absorbent compound should preferably be able to be changed thermally. The thermal change preferably occurs at a temperature of <600° C., particularly preferably at a temperature of <400° C., very particularly preferably at a temperature of <300° C., in particular <200° C. Such a change can be, for example, a decomposition or chemical change of the chromophoric centre of the light-absorbent compound.

The preferred embodiments of the light-absorbent compounds in the optical data carrier of the invention correspond to the preferred embodiments of the metal complex of the invention.

In a preferred variant, the light-absorbent compounds used are compounds of the formula (Ia) in which
R¹ is methyl, ethyl, propyl, butyl, cyanoethyl, methoxyethyl or benzyl,
R² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
X is O, CH₂ or a direct bond,
m and n are each, independently of one another, 1 or 2 and
M is Pd, Fe, Zn, Cu, Ni or Co.

In a particularly preferred variant, the light-absorbent compound used is a compound of the formula (Ia) in which
R¹ is methyl or ethyl, preferably methyl,
R² is methyl or trifluoromethyl, preferably trifluoromethyl,
X is CH₂ or a direct bond,
m and n are each 2 and
M is Zn, Cu, Ni or Co.

In a very particularly preferred embodiment, the light-absorbent compounds used are compounds of the formula III or IV

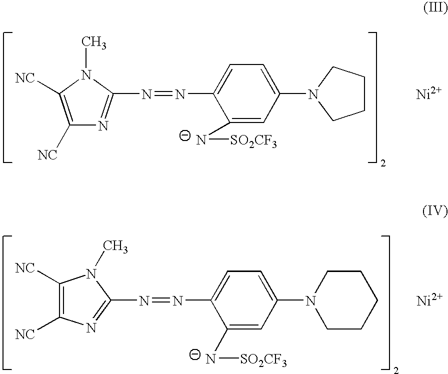

In a likewise preferred embodiment, the light-absorbent compounds used are compounds of the the formula (LIa),

where

R⁵¹ is substituted or unsubstituted C₆-C₁₀-aryl, in particular phenyl, a substituted or unsubstituted 5- or 6-membered heterocyclic radical, in particular pyridyl, substituted or unsubstituted C₁-C₆-alkylthio, substituted or unsubstituted C₇-C₁₀-aralkylthio, substituted or unsubstituted C₆-C₁₀-arylthio, in particular phenylthio, C₁-C₆-alkylsulphonyl, C₇-C₁₀-aralkylsulphonyl or substituted or unsubstituted C₆-C₁₀-arylsulphonyl, in particular phenylsulphonyl,
R⁵² is substituted or unsubstituted C₁-C₆-alkyl, in particular C₁-C₆-alkyl or perfluoro-C₁-C₆-alkyl,
R⁵³ and R⁵⁴ are each, independently of one another, substituted or unsubstituted C₁-C₆-alkyl, substituted or unsubstituted C₇-C₁₀-aralkyl or substituted or unsubstituted C₆-C₁₀-aryl or
NR⁵³R⁵⁴ is pyrrolidino, piperidino, morpholino, piperazino or N-C₁-C₆-alkyl-piperidino,
R⁵⁵ is hydrogen, methyl or methoxy or
R⁵³; R⁵⁵ together form a —(CH₂)₂—, —(CH₂)₃— or —(CH₂)₂—O— bridge, and
M is a metal.

In a particularly preferred embodiment, the light-absorbent compounds used are compounds of the formula (LIa) in which
R⁵¹ is phenyl,
R⁵² is methyl or trifluoromethyl, preferably trifluoromethyl,
R⁵³ and R⁵⁴ are each, independently of one another, methyl, ethyl, cyanoethyl or benzyl or
NR⁵³R⁵⁴ is pyrrolidino or piperidino,
R⁵⁵ is hydrogen and
M is Zn, Cu, Ni or Co,
   where the propyl or butyl radicals may also be branched.

In a very particularly preferred embodiment, the light-absorbent compounds used are compounds of the formula (LIa) in which
R⁵¹ is phenyl,
R⁵² is methyl or trifluoromethyl, preferably trifluoromethyl,
R⁵³ and R⁵⁴ are each, independently of one another, methyl, ethyl, cyanoethyl or benzyl or
NR⁵³R⁵⁴ is pyrrolidino or piperidino,
R⁵⁵ is hydrogen and
M is Zn, Cu, Ni or Co,
   where the propyl or butyl radicals may also be branched.

In an especially preferred embodiment, the light-absorbent compounds used are compounds of the formula (LIII), 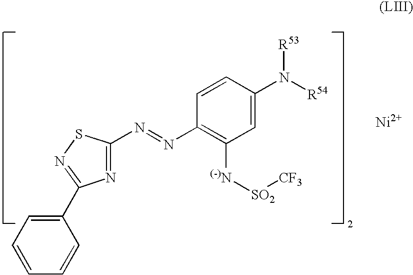
where
R⁵³ is methyl or ethyl,
R⁵⁴ is methyl, ethyl or cyanoethyl or
NR⁵³R⁵⁴ is pyrrolidino or piperidino.

In a preferred embodiment, the light-absorbent compounds used are compounds of the formula (CIa),

where

R¹⁰² is substituted or unsubstituted C₁-C₆-alkyl, in particular C₁-C₆-alkyl or perfluoro-C₁-C₆-alkyl,
R¹⁰³, R¹⁰⁴, R¹⁰⁶ and R¹⁰⁷ are each, independently of one another, substituted or unsubstituted C₁-C₆-alkyl, substituted or unsubstituted C₇-C₁₀-aralkyl or substituted or unsubstituted C₆-C₁₀-aryl or
NR¹⁰³R¹⁰⁴ and NR¹⁰⁶R¹⁰⁷ are each, independently of one another, pyrrolidino, piperidino, morpholino, piperazino or N—C₁-C₆-alkyl-piperidino,
R¹⁰⁵ is hydrogen, methyl or methoxy or
R¹⁰³; R¹⁰⁵ together form a —(CH₂)₂—, —(CH₂)₃— or —(CH₂)₂—O— bridge, and
M is a metal.

In a particularly preferred embodiment, the light-absorbent compounds used are compounds of the formula (CIa) in which
R¹⁰⁶ and R¹⁰⁷ are each, independently of one another, methyl, ethyl, propyl, butyl, cyanoethyl, chloroethyl, methoxyethyl, benzyl, phenethyl or phenyl or
NR¹⁰⁶R¹⁰⁷ is pyrrolidino, piperidino or morpholino,
R¹⁰² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
R¹⁰³ and R¹⁰⁴ are each, independently of one another, methyl, ethyl, propyl, butyl, cyanoethyl, chloroethyl, methoxyethyl, benzyl, phenethyl or phenyl or
NR¹⁰³R¹⁰⁴ is pyrrolidino, piperidino or morpholino,
R¹⁰⁵ is hydrogen and
M is Pd, Fe, Zn, Cu, Ni or Co,
   where the propyl or butyl radicals may also be branched.

In a very particularly preferred embodiment, the light-absorbent compounds used are compounds of the formula (CIa) in which
NR¹⁰⁶R¹⁰⁷ is dimethylamino, diethylamino, dipropylamino, N-cyanoethyl-N-methylamino, N-cyanoethyl-N-ethylamino, N,N-dicyanoethylamino, pyrrolidino or piperidino,
R¹⁰² is methyl or trifluoromethyl, preferably trifluoromethyl,
R¹⁰³ and R¹⁰⁴ are each, independently of one another, methyl, ethyl, cyanoethyl or benzyl or
NR¹⁰³R¹⁰⁴ is pyrrolidino or piperidino,
R¹⁰⁵ is hydrogen and
M is Zn, Cu, Ni or Co,
   where the propyl or butyl radicals may also be branched.

In an especially preferred embodiment, the light-absorbent compounds used are compounds of the formula (CIII), 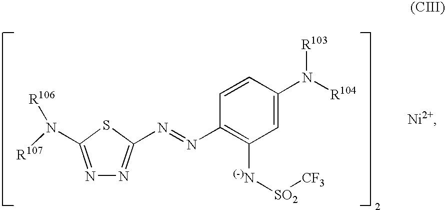
where
NR¹⁰⁶R¹⁰⁷ is dimethylamino, diisopropylamino or pyrrolidino,
R¹⁰³ is methyl or ethyl,
R¹⁰⁴ is methyl, ethyl or cyanoethyl or
NR¹⁰³R¹⁰⁴ is pyrrolidino or piperidino.

In the case of a write-once optical data carrier according to the invention which is written on and read by means of the light of a blue laser, preference is given to light-absorbent compounds whose absorption maximum λₘₐₓ₂ is in the range from 420 to 550 nm, where the wavelength λ_{1/2} in which the absorbence in the short wavelength flank of the absorption maximum at the wavelength λₘₐₓ₂ is half of the absorbence value at λₘₐₓ₂ and the wavelength λ_{1/10} at which the absorbence in the short wavelength flank of the absorption maximum at the wavelength λₘₐₓ₂ is one tenth of the absorbence value at λₘₐₓ₂ are preferably not more than 80 nm apart. Such a light-absorbent compound preferably has no shorter-wavelength maximum λₘₐₓ₁ down to a wavelength of 350 nm, particularly preferably down to 320 nm, very particularly preferably down to 290 nm.

Preference is given to light-absorbent compounds having an absorption maximum λₘₐₓ₂ of from 430 to 550 nm, in particular from 440 to 530 nm, very particularly preferably from 450 to 520 nm.

In these light-absorbent compounds, λ_{1/2} and λ_{1/10}, as defined above, are preferably not more than 70 nm apart, particularly preferably not more than 50 nm apart, very particularly preferably not more than 40 nm apart.

In the case of a write-once optical data carrier according to the invention which is written on and read by means of the light of a red laser, preference is given to light-absorbent compounds whose absorption maximum λₘₐₓ₂ is in the range from 500 to 650 nm, where the wavelength λ_{1/2} at which the absorbence in the long wavelength flank of the absorption maximum at the wavelength λₘₐₓ₂ is half of the absorbence value at λₘₐₓ₂ and the wavelength λ_{1/10} at which the absorbence in the long wavelength flank of the absorption maximum at the wavelength λₘₐₓ₂ is one tenth of the absorbence value at λₘₐₓ₂ are preferably not more than 60 nm apart. Such a light-absorbent compound preferably has no longer-wavelength maximum λₘₐₓ₃ up to a wavelength of 750 nm, particularly preferably 800 nm, very particularly preferably 850 nm.

Preference is given to light-absorbent compounds having an absorption maximum λₘₐₓ₂ of from 510 to 620 nm.

Particular preference is given to light-absorbent compounds having an absorption maximum λₘₐₓ₂ of from 530 to 610 nm.

Very particular preference is given to light-absorbent compounds having an absorption maximum λₘₐₓ₂ of from 550 to 600 nm.

In these light-absorbent compounds, λ_{1/2} and λ_{1/10}, as defined above, are preferably not more than 50 nm apart, particularly preferably not more than 40 nm apart, very particularly preferably not more than 30 nm apart.

The light-absorbent compounds preferably have a molar extinction coefficient ε of >30 000 l/mol cm, more preferably >50 000 l/mol cm, particularly preferably >70 000 l/mol cm, very particularly preferably >100 000 l/mol cm, at the absorption maximum λₘₐₓ₂.

The absorption spectra are measured, for example, in solution.

Suitable light-absorbent compounds having the required spectral properties are, in particular, those which have a low solvent-induced wavelength shift (dioxane/DMF or methylene chloride/methanol). Preference is given to metal complexes whose solvent-induced wavelength shift Δλ_{DD}=|λ_{DMF}−λ_{dioxane}|, i.e. the positive difference between the absorption wavelengths in the solvents dimethylformamide and dioxane, or whose solvent-induced wavelength shift Δλ_{MM}=|λₘₑₜₕₐₙₒₗ−λ_{methylene chloride}|, i.e. the positive difference between the absorption wavelengths in the solvents methanol and methylene chloride, are <20 nm, particularly preferably <10 nm, very particularly preferably <5 nm.

Preference is given to a write-once optical data carrier according to the invention which is written on and read by means of the light of a red or blue laser, in particular a red laser.

Other metal complexes are known, for example, from U.S. Pat. No. B1 6,225,023.

The light-absorbent compounds used according to the invention guarantee a sufficiently high reflectivity (>10%) of the optical data carrier in the unwritten state and a sufficiently high absorption for thermal degradation of the information layer on point-wise elimination with focussed light if the wavelength of the light is in the range from 360 to 460 nm and from 600 to 680 nm. The contrast between written and unwritten points on the data carrier is achieved by the reflectivity change of the amplitude and also the phase of the incident light due to the changed optical properties of the information layer after the thermal degradation.

The metal complexes of the invention are preferably applied to the optical data carrier by spin coating or vacuum vapour deposition, in particular spin coating. They can be mixed with one another or else with other dyes having similar spectral properties. The information layer can comprise not only the metal complexes of the invention but also additives such as binder, wetting agents, stabilizers, diluents and sensitizers and also further constituents.

Apart from the information layer, further layers such as metal layers, dielectric layers and protective layers may be present in the optical data store of the invention. Metals and dielectric layers serve, inter alia, to adjust the reflectivity and the heat absorption/retention. Metals can be, depending on the laser wavelength, gold, silver, aluminium, etc. Examples of dielectric layers are silicon dioxide and silicon nitride. Protective layers are, for example, photocurable surface coatings, (pressure-sensitive) adhesive layers and protective films.

Pressure-sensitive adhesive layers consist mainly of acrylic adhesives. Nitto Denko DA-8320 or DA-8310, disclosed in the patent JP-A 11-273147, can, for example, be used for this purpose.

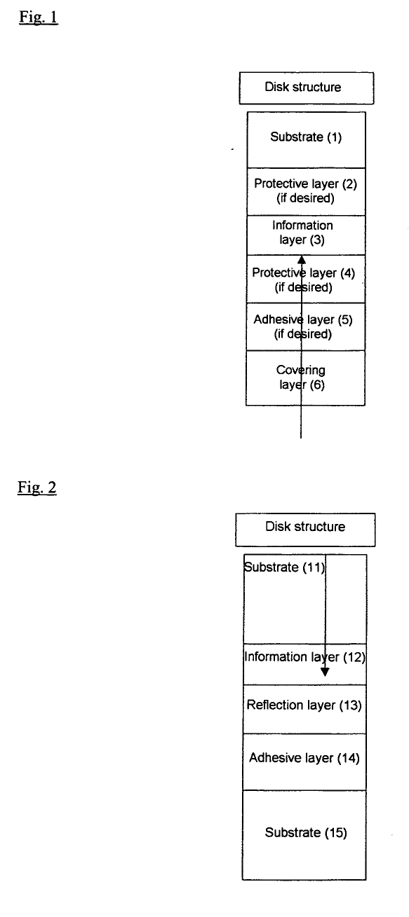

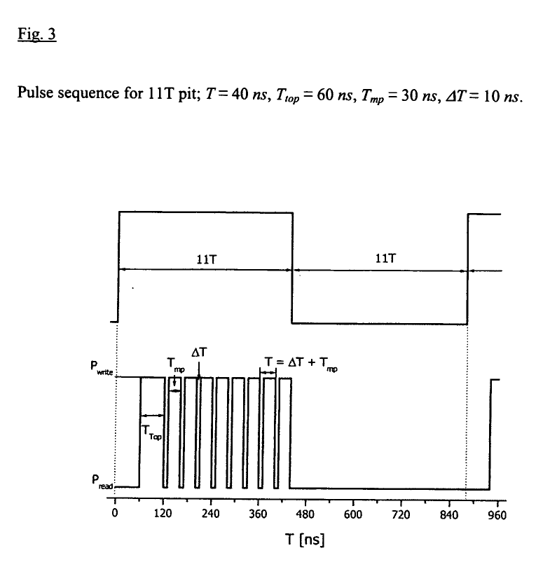

The optical data carrier of the invention has, for example, the following layer structure (cf. FIG. 1): a transparent substrate (1), if desired a protective layer (2), an information layer (3), if desired a protective layer (4), if desired an adhesive layer (5), a covering layer (6). The arrows shown in FIG. 1 and FIG. 2 indicate the path of the incident light.

The structure of the optical data carrier preferably:
comprises a preferably transparent substrate (1) to whose surface at least one light-writable information layer (3) which can be written on by means of light, preferably laser light, if desired a protective layer (4), if desired an adhesive layer (5) and a transparent covering layer (6) have been applied.
comprises a preferably transparent substrate (1) to whose surface a protective layer (2), at least one information layer (3) which can be written on by means of light, preferably laser light, if desired an adhesive layer (5) and a transparent covering layer (6) have been applied.
comprises a preferably transparent substrate (1) to whose surface a protective layer (2) if desired, at least one information layer (3) which can be written on by means of light, preferably laser light, if desired a protective layer (4), if desired an adhesive layer (5) and a transparent covering layer (6) have been applied.
comprises a preferably transparent substrate (1) to whose surface at least one information layer (3) which can be written on by means of light, preferably laser light, if desired an adhesive layer (5) and a transparent covering layer (6) have been applied.

Alternatively, the optical data carrier has, for example, the following layer structure (cf. FIG. 2): a preferably transparent substrate (11), an information layer (12), if desired a reflection layer (13), if desired an adhesive layer (14), a further preferably transparent substrate (15).

The invention further provides optical data carriers according to the invention which have been written on by means of blue or red light, in particular laser light, especially red laser light.

The following examples illustrate the subject-matter of the invention.

### EXAMPLES

### Example 1

a) 20 g of 2-amino-4,5-dicyanoimidazole were suspended in 600 ml of water and admixed with 100 ml of 35 percent strength by weight hydrochloric acid. Virtually everything went into solution. At 0-5° C., 33.5 ml of an aqueous solution of sodium nitrite containing 30 g of sodium nitrite in 100 ml of solution were added dropwise over a period of 1.5 hours. The beige suspension was stirred at 0-5° C. for another 1 hour, with a further 3 ml of the above sodium nitrite solution being added dropwise to maintain an excess of nitrite.
b) 63.5 g of N-(3-trifluoromethanesulphonylaminophenyl)pyrrolidine, 6 g of urea and 50.5 g of sodium acetate together with 650 ml of methanol were placed in a reaction vessel. The suspension from a) was slowly added at 0-5° C. over a period of 1.5 hours. The mixture was stirred for another 3 hours at 0-5° C. and then overnight at room temperature. The precipitated dye of the formula 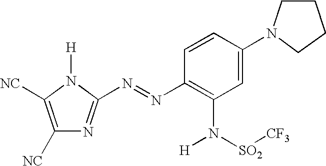
was filtered off with suction as a reddish brown powder and was washed with 500 ml of water. Drying gave 46.9 g (92% of theory) of product. λₘₐₓ in methanol=485 nm.
c) 39.6 g of the dye from b) were suspeneded in 900 ml of methanol. 12 g of dimethyl sulphate were added dropwise at room temperature. After addition of 13.1 g of anhydrous potassium carbonate, the mixture was stirred at room temperature for 5 hours. A further 12 g of dimethyl sulphate and 13.1 g of anhydrous potassium carbonate were then added. After a further 5 hours at room temperature, the mixture was filtered with suction and the solid was washed with 3×20 ml of methanol. The product was stirred in 200 ml of water, filtered off with suction, washed with 3×20 ml of water and dried. This gave 33.9 g (83% of theory) of a red powder of the formula 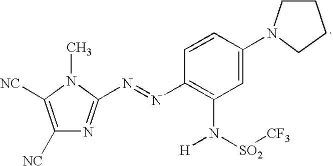
d) 10.8 g of the dye from c) together with 200 ml of methanol were placed in a reaction vessel at 50° C. 2.97 g of nickel acetate tetrahydrate were introduced over a period of 15 minutes, with everything going temporarily into solution. After 1 hour at 50° C., the mixture was cooled to 5-10° C., filtered with suction and the solid was washed with 5×3 ml of methanol. Drying gave 9.1 g (79% of theory) of a red powder of the formula 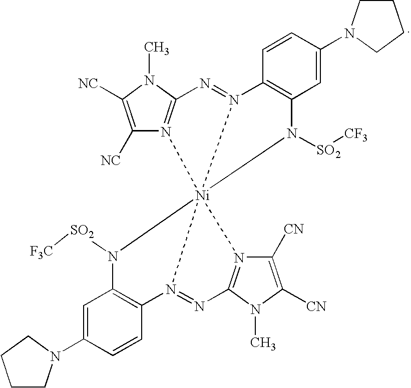
m.p.>300° C.
molar mass=961.54
λₘₐₓ=540, 578 nm (dioxane)
λₘₐₓ=541, 578 nm (dimethylformamide)=
ε=106 440 l/mol cm (at 578 nm in dioxane)=
ε=142 900 l/mol cm (at 578 nm in dimethylformamide)
λ_{1/2}-λ_{1/10} (long wavelength flank)=16 nm
Δλ=|λ_{DMF}−λ_{dioxane}|=0 nm
solubility: 10% in TFP (2,2,3,3-tetrafluoropropanol)
glass-like film

The coupling component used in b) was prepared as follows:

6.0 g of N-(3-nitrophenyl)pyrrolidine (prepared as described in Chem. Pharm. Bull., 1998, 46, 951) were hydrogenated in 28 ml of methanol together with 0.5 g of Raney nickel at 50° C. and a hydrogen pressure of 50 bar. The catalyst was filtered off, washed with a little methanol and the filtrate was evaporated under reduced pressure. This gave 4.4 g (87% of theory) of the amine of the formula 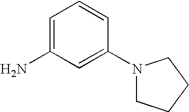
as a brown oil.

4.4 g of this oil were dissolved in 18 ml of water-free toluene. At 0-5° C., 10.8 g of trifluoromethanesulphonic anhydride were added dropwise. After 1 hour at this temperature and 2 hours at room temperature, the solution was poured into a mixture of 250 ml of ice water and 50 ml of chloroform. The phases were separated and the organic phase was shaken again with 100 ml of water. Finally, the organic phase was evaporated on a rotary evaporator. This gave 5.7 g (71% of theory) of the sulphonamide of the formula 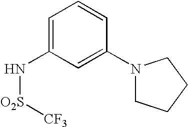
as a brown oil.

Metal complexes which are likewise suitable are shown in the following examples and in Table 1. These are obtained by analogous preparation of the coupling components, azo dye and metal complexes.

### Example 2

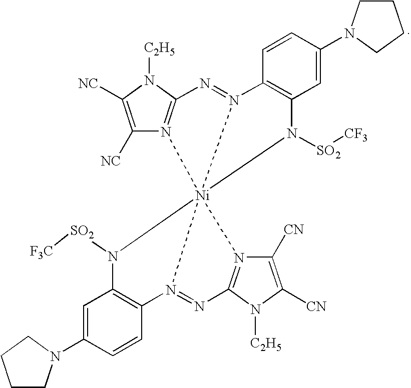

λₘₐₓ=540, 578 nm (dioxane)

solubility: 10% in TFP (2,2,3,3-tetrafluoropropanol)

glass-like film

### Example 3

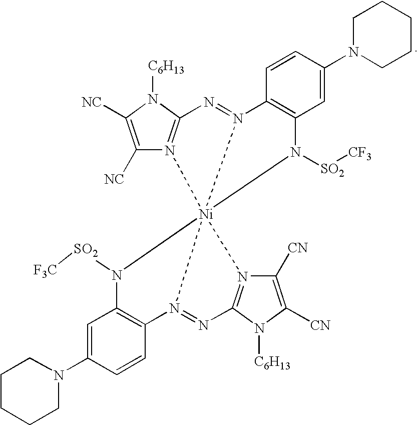

λₘₐₓ=540, 580 nm (dioxane)

glass-like film

### Example 4

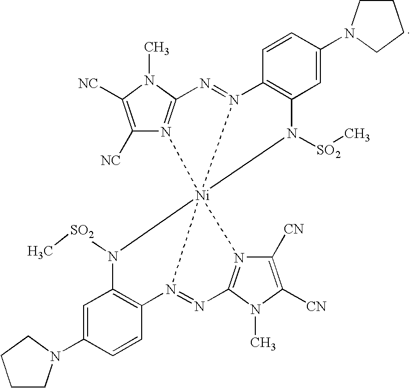

m.p.>300° C.

k×=542 nm (methylene chloride)=

ε=80 820 l/mol cm

λ_{1/2}-λ_{1/10} (long wavelength flank)=24 nm

solubility: >2% in TFP (2,2,3,3-tetrafluoropropanol)

glass-like film

TABLE 1

| Example | R¹ | R² | 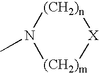 | M | λₘₐₓ | ε | M.p. |
|---|---|---|---|---|---|---|---|
| 5 | CH₃ | CF₃ | 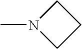 | Ni | | | |
| 6 | 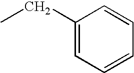 | CF₃ | 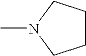 | Co | | | |
| 7 | CH₃ | CF₃ | 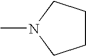 | Zn | | | |
| 8 | CH₃ | CF₃ | 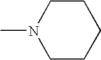 | Cu | | | |
| 9 | C₄H₉ | CF₃ | 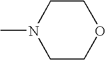 | Ni | | | |
| 10 | CHF₂ | C₄F₉ | 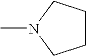 | Ni | | | |
| 11 | CH₃ | C₂F₅ | 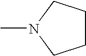 | Ni | | | |
| 12 | CH₃ | CF₃ | 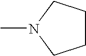 | Co | 543, 584^{b)} | 111 120 | >300° C. |
| 13 | CH₃ | CF₃ | 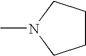 | Cu | 544, 583^{b)} | 140 870 | >300° C. |
| 14 | CH₃ | CF₃ | 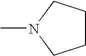 | Zn | 536, 575^{b)} | 161 865 | >300° C. |
| 15 | CH₃ | CF₃ | 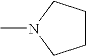 | Pd | | | |
| 16 | CH₃ | CF₃ | 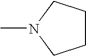 | Fe | | | |
| 17 | CH₃ | CF₃ | 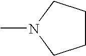 | Ba | | | |
| 18 | C₂H₅ | CF₃ | 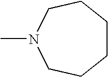 | Ni | | | |
| 19 | CH₃ | CF₃ | 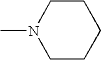 | Ni | | | |
| 20 | CH₃ | CF₃ | 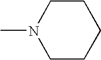 | Co | | | |
| 21 | CH₃ | C₂H₅ | 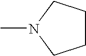 | Ni | | | |
| 22 | CH₃ | CH₂CF₃ | 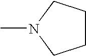 | Co | | | |
| 23 | (CH₂)₂CN | CF₃ | 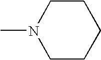 | Ni | | | |
| 24 | (CH₂)₂OH | CF₃ | 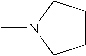 | Zn | | | |
| 25 | CH₃ | CF₃ | 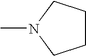 | Fe | | | |
| 26 | CH₃ | C₄H₉ | 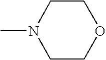 | Pd | | | |
| 27 | CH₃ | CF₃/CH₃^{a)} | 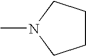 | Ni | | | |
| 28 | CH₃/C₂H₅^{a)} | CF₃ | 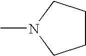 | Co | | | |
| 28a | H | CF₃ | 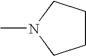 | Ni | 534, 573^{b)} | 123 666 | >300° C. |

^{a)}random mixture
^{b)}in chloroform
solubility:
>2% in TFP
2% in butanol

### Example 29

a) 7.9 g of 2-amino-5-phenyl-1,2,4-thiadiazole were dissolved in 30 ml of glacial acetic acid and 15 ml of formic acid with gentle heating. After cooling to 0° C., 3.1 g of sodium nitrite were introduced over a period of 10 minutes. The mixture was stirred at 0-5° C. for 2 hours.
b) 15.9 g of 3-methanesulphonyl-N,N-diethylaniline were dissolved in 15 ml of glacial acetic acid. This solution was slowly added to the nitrosation mixture from a) at 5° C.
c) The mixture was subsequently warmed slowly to room temperature and finally heated at 95° C. for 1 hour. After 1 hour at 95° C., the mixture was cooled, filtered with suction, the solid was washed with 5 ml of glacial acetic acid and 50 ml of water and dried under reduced pressure. This gave 5.5 g (29% of theory) of a red powder of the formula 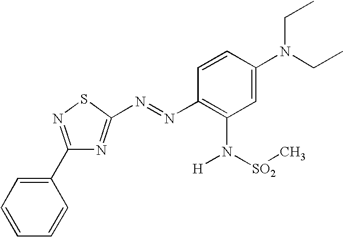
m.p. 231° C.
λₘₐₓ=517 nm (in DMF).
d) 0.58 g of nickel acetate tetrahydrate were dissolved 40 ml of ethanol at 50° C. 2.0 g of the dye from c) were added over a period of 15 minutes. After 3 hours at 50° C., the mixture was cooled, filtered with suction, the solid was washed with 5 ml of ethanol and 20 ml of water and dried under reduced pressure. This gave 1.9 g (90% of theory) of a red powder of the formula 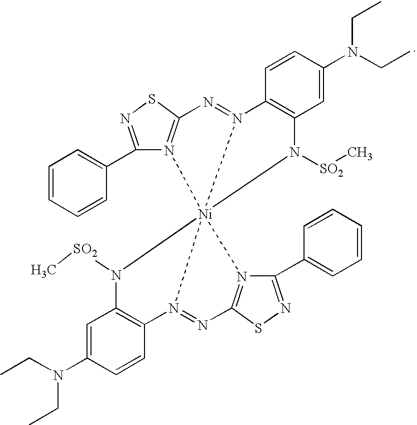
m.p.>280° C.,
λₘₐₓ=552 nm (methylene chloride)
ε=100 076 l/mol cm
λ_{1/2}λ_{1/10} (long wavelength flank)=24 nm
solubility: >2% in TFP (2,2,3,3-tetrafluoropropanol)
glass-like film

Metal complexes which are likewise suitable are shown in the following examples and in Table 2. These are obtained by analogous preparation of the coupling components, azo dyes and metal complexes.

### Example 30

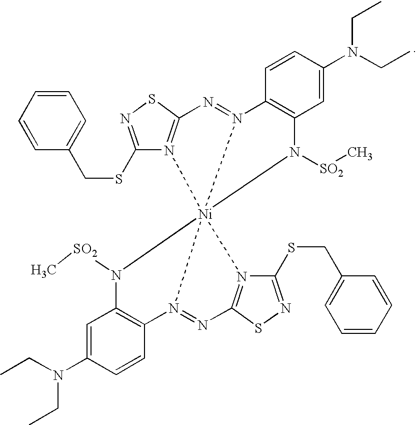

m.p.>280° C.

λₘₐₓ=555 nm (methylene chloride)

ε=90 300 l/mol cm

λ_{1/2}-λ_{1/10} (long wavelength flank)=24 nm

solubility: >2% in TFP (2,2,3,3-tetrafluoropropanol)

glass-like film

TABLE 2

| Example | 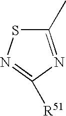 | 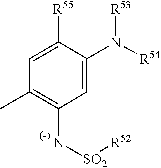 | M | λₘₐₓ | ε | M.p. |
|---|---|---|---|---|---|---|
| 31 | 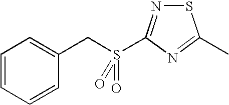 | 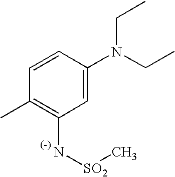 | Ni | | | |
| 32 | 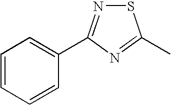 | 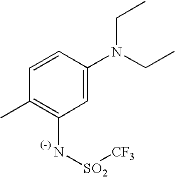 | Ni | 535, 577^{b)} | 141 220 | >300° C. |
| 32a | 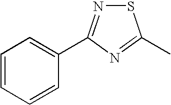 | 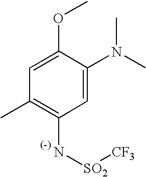 | Co | 537, 585^{b)} | 104 590 | >300° C. |
| 32b | 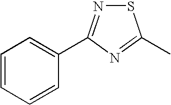 | 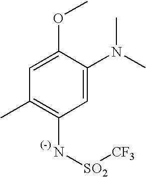 | Cu | 542, 578^{b)} | 120 490 | >300° C. |
| 32c | 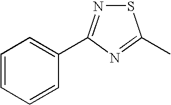 | 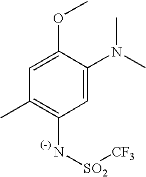 | Zn | 535, 575^{b)} | 135 285 | >300° C. |
| 32d | 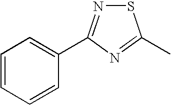 | 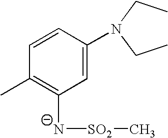 | Co | 546^{c)} | 95 510 | >300° C. |
| 33 | 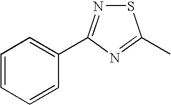 | 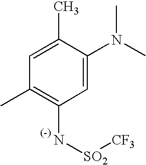 | Co | | | |
| 34 | 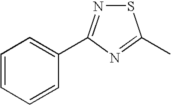 | 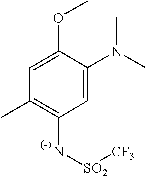 | Ni | | | |
| 35 | 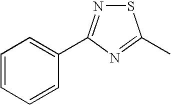 | 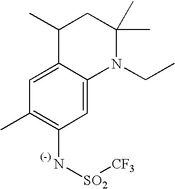 | Ni | | | |
| 36 | 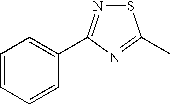 | 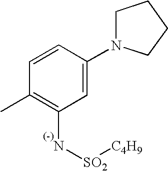 | Cu | | | |
| 37 | 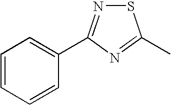 | 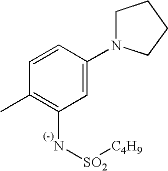 | Zn | | | |
| 38 | 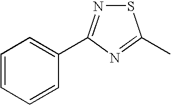 | 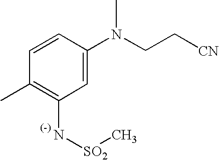 | Ni | | | |
| 39 | 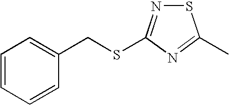 | 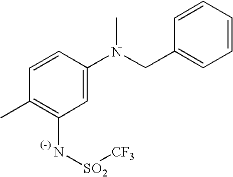 | Ni | | | |
| 40 | 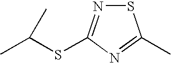 | 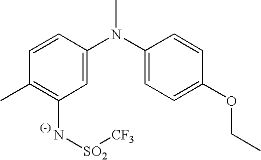 | Co | | | |
| 41 | 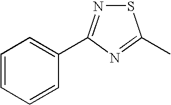 | 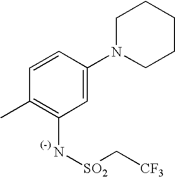 | Pd | | | |
| 42 | 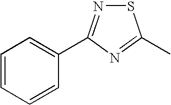 | 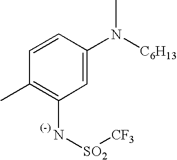 | Fe | | | |
| 43 | 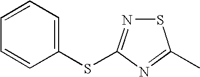 | 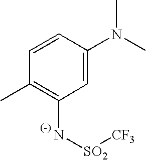 | Ni | | | |
| 44 | 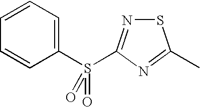 | 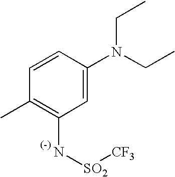 | Ni | | | |
| 45 | 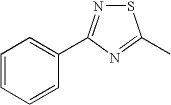 | 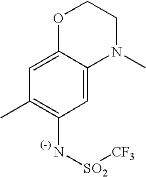 | Ni | | | |
| 46 | 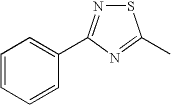 | 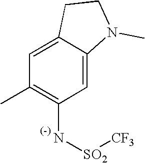 | Co | | | |
| 47 | 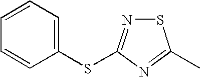 | 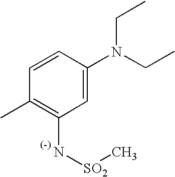 | Zn | | | |
| 48 | 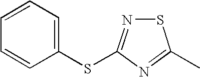 | 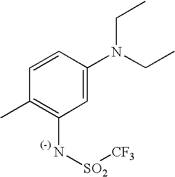 | Ba | | | |
| 49 | 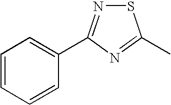 | 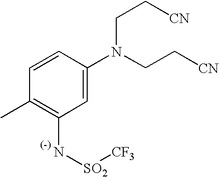 | Cu | | | |
| 50 | 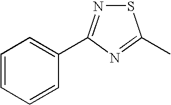 | 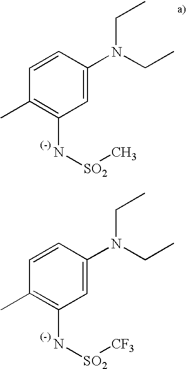 | Ni | | | |
| 50a | 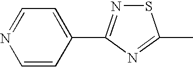 | 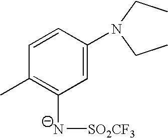 | Ni | | | |

^{a)}random mixture
^{b)}in chloroform
^{c)}in methylene chloride

### Example 51

a) 20 g of 2-amino-5-diisopropylamino-1,3,4-thiadiazole and 36.5 g of 3-methanesulphonylamino-N,N-diethylaniline were dissolved in 200 ml of glacial acetic acid. At 10-15° C., a 5-molar aqueous solution of sodium nitrite was added dropwise over a period of 90 minutes. After stirring overnight at room temperature, the mixture was poured into 600 g of ice water, filtered with suction, the solid was washed with 500 ml of water and dried at 50° C. under reduced pressure. This gave 35 g (77% of theory) of the dye of the formula 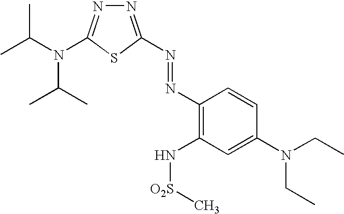
as a red powder.
m.p. 196-200° C.
λₘₐₓ=506, 526 nm (in dioxane).
b) 0.95 g of the dye from a) and 0.16 g of sodium acetate together with a mixture of 30 ml of tetrahydrofuran and 15 ml of water were placed in a reaction vessel. A solution of 0.3 g of nickel acetate tetrahydrate in 6 ml of methanol was added. The mixture was stirred overnight. 80 ml of water were added to precipitate the product, and the product was filtered off with suction and washed with 5 ml of water. Drying under reduced pressure gave 0.6 g (62% of theory) of the metal complex of the formula 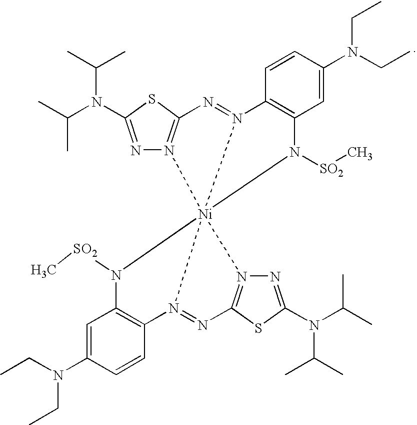
as a blue powder.
m.p.>280° C.
λₘₐₓ=541, 591 nm (dioxane)
ε=53237 l/mol cm
λ_{1/2}-λ_{1/10} (long wavelength flank)=30 nm
solubility: >2% in TFP (2,2,3,3-tetrafluoropropanol)>
   2% in butanol
glass-like film from butanol or TFP

Metal complexes which are likewise suitable are shown in the following examples and in Table 3. These are obtained by analogous preparation of the coupling components, azo dyes and metal complexes.

### Example 52

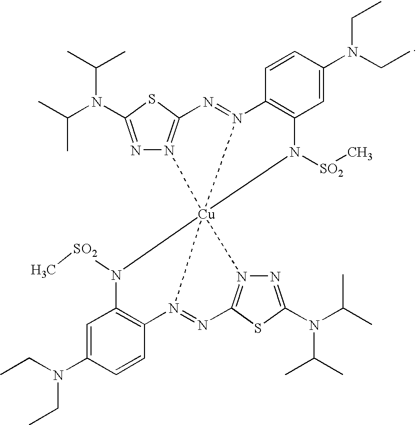

λₘₐₓ=613 nm (methanol)

solubility: >2% in TFP (2,2,3,3-tetrafluoropropanol)

glass-like film

### Example 53

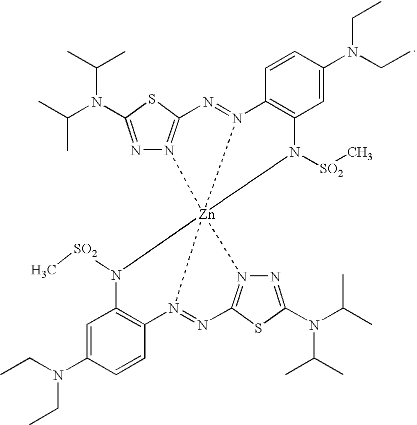

λₘₐₓ=554 nm (methanol)

solubility: >2% in TFP (2,2,3,3-tetrafluoropropanol)

glass-like film

TABLE 3

| Example | 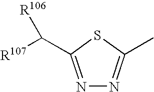 | 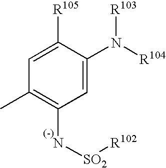 | M |
|---|---|---|---|
| 54 | 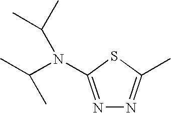 | 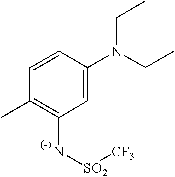 | Ni |
| 55 | 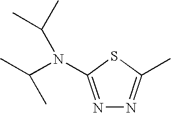 | 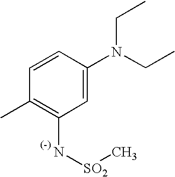 | Co |
| 56 | 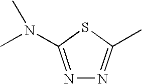 | 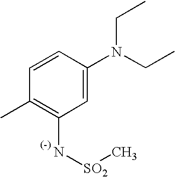 | Zn |
| 57 | 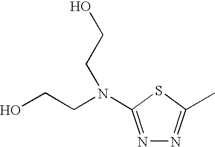 | 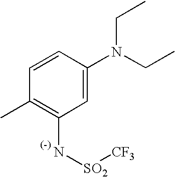 | Ni |
| 58 | 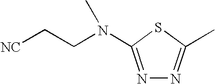 | 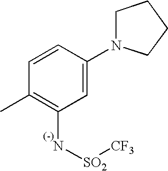 | Ni |
| 59 | 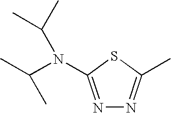 | 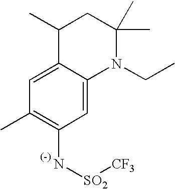 | Cu |
| 60 | 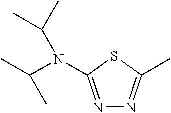 | 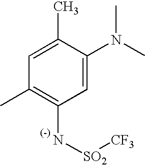 | Pd |
| 61 | 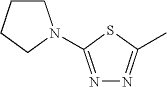 | 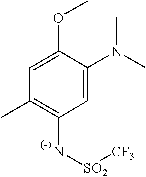 | Co |
| 62 | 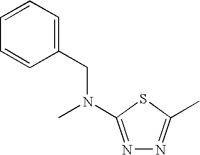 | 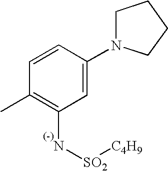 | Ni |
| 63 | 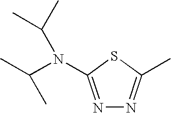 | 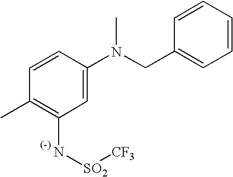 | Ni |
| 64 | 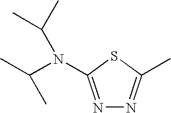 | 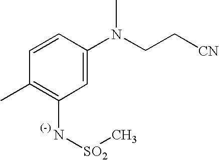 | Fe |
| 65 | 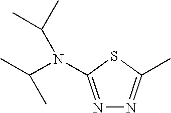 | 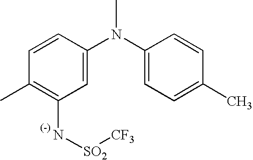 | Zn |
| 66 | 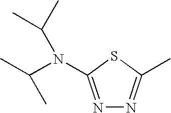 | 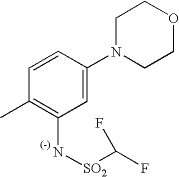 | Ba |
| 67 | 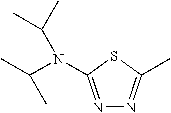 | 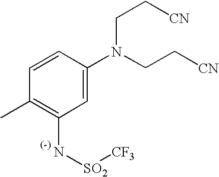 | Ni |
| 68 | 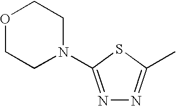 | 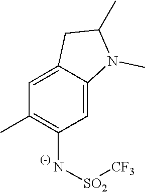 | Ni |
| 69 | 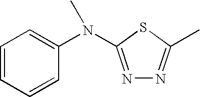 | 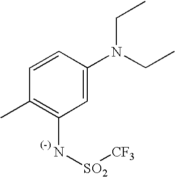 | Co |
| 70 | 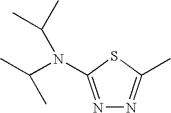 | 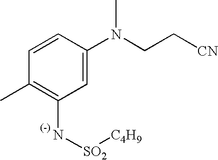 | Ni |
| 71 | 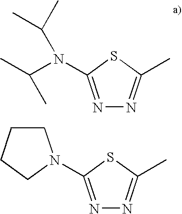 | 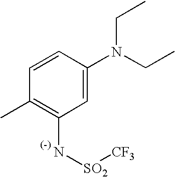 | Ni |
| 72 | 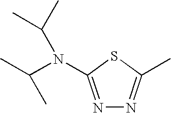 | 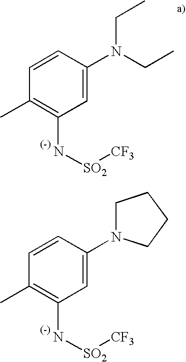 | Ni |
| 73 | 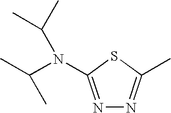 | 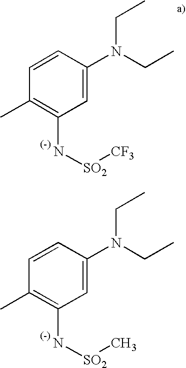 | Cu |

^{a)}random mixture

### Example 74

### Preparation of a Concentrated Solution

909 mg of the azo dye from Example 1c) together with 11.1 g of 2,2,3,3,-tetrafluoropropanol were placed in a reaction vessel at 50° C. 249 mg of nickel acetate tetrahydrate were introduced, with everything going into solution. After 1 hour at 50° C., the mixture was cooled to room temperature. This gave 12.1 g of a red solution which contained 8 percent by weight of the metal complex of the formula

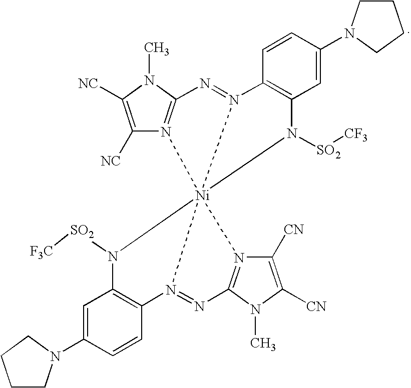

It was filtered in succession through 5 μm, 1.2 μm, 0.45 μm and 0.2 μm filters (Sartorius Minisart® single-use filters). This solution is stable on storage and, after dilution to the desired concentration, is suitable for coating optical data carriers by means of spin coating.

### Example 74a

A similar result is achieved when 270 mg of nickel acetylacetonate are used in place of nickel acetate tetrahydrate.

### Example 75

A 3% strength by weight solution of the metal complex from Example 29 in 2,2,3,3-tetrafluoropropanol was prepared at room temperature. This solution was applied by means of spin coating to a pregrooved polycarbonate substrate. The pregrooved polycarbonate substrate had been produced as a disk by means of injection moulding. The dimensions of the disk and the groove structure corresponded to those customarily used for DVD-Rs. The disk with the dye layer as information carrier was coated with 100 nm of silver by vapour deposition. A UV-curable acrylic coating composition was subsequently applied by spin coating and cured by means of a UV lamp. The disk was tested by means of a dynamic writing test apparatus constructed on an optical tester bench and comprising a diode laser (λ=656 nm) for generating linearly polarized light, a polarization-sensitive beam splitter, a λ/4 plate and a movably suspended collecting lens having a numerical aperture NA=0.6 (actuator lens). The light reflected from the reflection layer of the disk was taken out from the beam path by means of the abovementioned polarization-sensitive beam splitter and focussed by means of an astigmatic lens onto a four-quadrant detector. At a linear velocity V=3.5 m/s and a writing power P_{write}=11 mW, a signal/noise ratio C/N=49 dB was measured for 11 T pits. The writing power was applied as an oscillating pulse sequence (cf. FIG. 1), with the disk being irradiated alternately with the abovementioned writing power P_{write} and the reading power P_{read}=0.5 mW. The writing pulse sequence for the 11 T pit comprised a lead pulse having a length Tₜₒₚ=1.5 T=60 ns, where T=40 ns is the base time (11 T=440 ns). The lead pulse was placed so that it ended after 3 T units. It was followed by eight pulses having a length Tₘₚ=30 ns, with the time being determined by Tₘₚ=0.75 T. A time interval ΔT=10 ns thereforre remains free between each writing pulse. The 11 T long writing pulse was followed by an 11 T long pause. The disk was irradiated with this oscillating pulse sequence until it had rotated once. The marking produced in this way was then read using the reading power P_{read} and the abovementioned signal/noise ratio C/N was measured.

### Example 76

The procedure of Example 75 was repeated using the metal complex from Example 1, and a signal/noise ratio C/N=50 dB was measured in this case.

Analogous results were obtained using the metal complexes from the other examples described above.

1. Metal complexes which have at least one ligand of the formula I 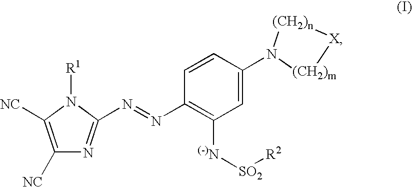
where
R¹ is hydrogen, substituted or unsubstituted C₁-C₆-alkyl or substituted or unsubstituted C₇-C₁₂-aralkyl,
R² is substituted or unsubstituted C₁-C₆-alkyl,
X is O, NH, NR³, CH₂ or a direct bond,
R³ is substituted or unsubstituted C₁-C₆-alkyl and
m and n are each, independently of one another, 1, 2 or 3,
and metal complexes which have at least one of the ligands of the formula (LI) 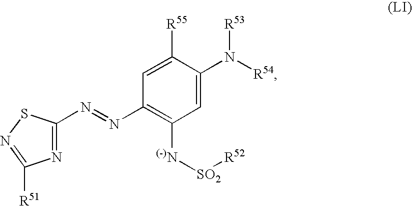
where
R⁵¹ is substituted or unsubstituted C₆-C₁₀-aryl, optionally phenyl, a substituted or unsubstituted 5- or 6-membered heterocyclic radical, optionally pyridyl, C₁-C₆-alkylthio, C₇-C₁₀-aralkylthio, substituted or unsubstituted C₆-C₁₀-arylthio, in particular optionally phenylthio, C₁-C₆-alkylsulphonyl, C₇-C₁₀-aralkylsulphonyl or substituted or unsubstituted C₆-C₁₀-arylsulphonyl, optionally phenylsulphonyl,
R⁵² is substituted or unsubstituted C₁-C₆-alkyl,
R⁵³ and R⁵⁴ are each, independently of one another, substituted or unsubstituted C₁-C₆-alkyl, substituted or unsubstituted C₇-C₁₀-aralkyl or substituted or unsubstituted C₆-C₁₀-aryl or
NR⁵³R⁵⁴ is pyrrolidino, piperidino, morpholino, piperazino or N—C₁-C₆-alkyl-piperidino,
R⁵⁵ is hydrogen, methyl or methoxy or
R⁵³, R⁵⁵ together form a —(CH₂)₂—, —(CH₂)₃— or —(CH₂)₂—O— bridge,
and metal complexes which have at least one ligand of the formula (CI) 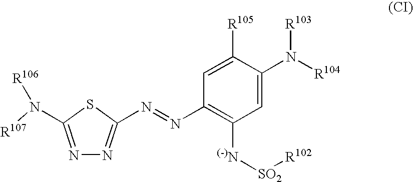
where
R¹⁰² is substituted or unsubstituted C₁-C₆-alkyl, optionally C₁-C₆-alkyl or perfluoro-C₁-C₆-alkyl,
R¹⁰³, R¹⁰⁴, R¹⁰⁶ and R¹⁰⁷ are each, independently of one another, substituted or unsubstituted C₁-C₆-alkyl, substituted or unsubstituted C₇-C₁₀-aralkyl or substituted or unsubstituted C₆-C₁₀-aryl or
NR¹⁰³R¹⁰⁴ and NR¹⁰⁶R¹⁰⁷ are each, independently of one another, pyrrolidino, piperidino, morpholino, piperazino or N—C₁-C₆-alkyl-piperidino,
R¹⁰⁵ is hydrogen, methyl or methoxy or
R¹⁰³, R¹⁰⁵ together form a —(CH₂)₂—, —(CH₂)₃— or —(CH₂)₂—O— bridge.

2. Metal complexes according to claim 1, characterized in that they contain two identical or different ligands of the formula (I), (LI) or (CI).

3. Metal complexes according to claim 1, characterized in that they have the formula (Ia)
[(I)]₂⁻M²⁺ (Ia)
where the two ligands of the formula (I) are each, independently of one another, as defined in claim 1 and
M is a metal, or
have the formula (LIa)
[(LI)]₂⁻M²⁺ (LIa)
where the two ligands are each, independently of one another, as defined in claim 1 and
M is a metal, or
have the formula (CIa)
[(CI)]₂⁻M²⁺ (CIa)
where the two ligands of the formula (LI) are each, independently of one another, as defined in claim 1 and
M is a metal.

4. Metal complexes according to claim 1, characterized in that they have the formula (Ia)
[(I)]₂⁻M²⁺ (Ia)
where the two ligands of the formula (I) are each, independently of one another, as defined in claim 1 and
M is a metal.

5. Metal complexes according to claim 1, characterized in that the metal is a divalent metal, transition metal or rare earth, in particular optionally Mg, Ca, Sr, Ba, Cu, Ni, Co, Fe, Zn, Pd, Pt, Ru, Rh, Os, Sm.

6. Metal complexes according to claim 1, characterized in that the metal is Pd, Fe, Zn, Cu, Ni or Co.

7. Metal complexes according to claim 1, characterized in that, in the formula (I)
R¹ is methyl, ethyl, propyl, butyl, cyanoethyl, methoxyethyl or benzyl,
R² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
X is O, CH₂ or a direct bond,
m and n are each, independently of one another, 1 or 2 and
M is Pd, Fe, Zn, Cu, Ni or Co,
or complexes in which, in the formula (LI)
R⁵¹ is phenyl, pyridyl, methylthio, ethylthio, propylthio, benzylthio, methyl-sulphonyl, benzylsulphonyl or phenylsulphonyl,
R⁵² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
R⁵³ and R⁵⁴ are each, independently of one another, methyl, ethyl, propyl, butyl, cyanoethyl, chloroethyl, methoxyethyl, benzyl, phenethyl or phenyl or
NR⁵³R⁵⁴ is pyrrolidino, piperidino or morpholino,
R⁵⁵ is hydrogen and
M is Pd, Fe, Zn, Cu, Ni or Co,
where the propyl or butyl radicals may also be branched,
or complexes in which, in the formula (CI)
R¹⁰⁶ and R¹⁰⁷ are each, independently of one another, methyl, ethyl, propyl, butyl, cyanoethyl, chloroethyl, methoxyethyl, benzyl, phenethyl or phenyl or
NR¹⁰⁶R¹⁰⁷ is pyrrolidino, piperidino or morpholino,
R¹⁰² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
R¹⁰³ and R¹⁰⁴ are each, independently of one another, methyl, ethyl, propyl, butyl, cyanoethyl, chloroethyl, methoxyethyl, benzyl, phenethyl or phenyl or
NR¹⁰³R¹⁰⁴ is pyrrolidino, piperidino or morpholino,
R¹⁰⁵ is hydrogen and
M is Pd, Fe, Zn, Cu, Ni or Co,
where the propyl or butyl radicals may also be branched.

8. Metal complexes as claimed in claim 1, characterized in that
R¹ is methyl or ethyl,
R² is methyl or trifluoromethyl,
X is CH₂ or a direct bond,
m and n are each 2 and
M is Zn, Cu, Ni or Co,
or complexes in which, in the formula (LI)
R⁵¹ is phenyl,
R⁵² is methyl or trifluoromethyl, preferably trifluoromethyl,
R⁵³ and R⁵⁴ are each, independently of one another, methyl, ethyl, cyanoethyl or benzyl or
NR⁵³R⁵⁴ is pyrrolidino or piperidino,
R⁵⁵ is hydrogen and
M is Zn, Cu, Ni or Co,
where the propyl or butyl radicals may also be branched,
or complexes in which, in the formula (CI)
NR¹⁰⁶R¹⁰⁷ is dimethylamino, diethylamino, dipropylamino, N-cyanoethyl-N-methylamino, N-cyanoethyl-N-ethylamino, N,N-dicyanoethylamino, pyrrolidino or piperidino,
R¹⁰² is methyl or trifluoromethyl, preferably trifluoromethyl,
R¹⁰³ and R¹⁰⁴ are each, independently of one another, methyl, ethyl, cyanoethyl or benzyl or
NR¹⁰³R¹⁰⁴ is pyrrolidino or piperidino,
R¹⁰⁵ is hydrogen and
M is Zn, Cu, Ni or Co,
where the propyl or butyl radicals may also be branched.

9. Metal complexes according to claim 1, characterized in that they correspond to the formula III or IV or the formula (LIII) or the formula (CIII) 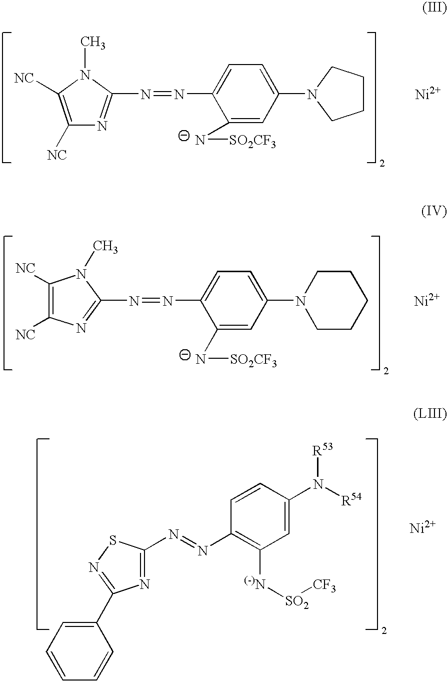
where
R⁵³ is methyl or ethyl,
R⁵⁴ is methyl, ethyl or cyanoethyl or
NR⁵³R⁵⁴ is pyrrolidino or piperidino, 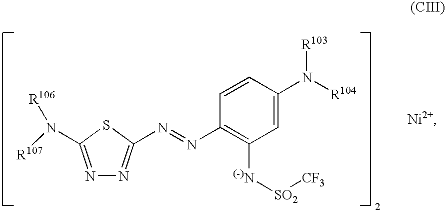
where
NR¹⁰⁶R¹⁰⁷ is dimethylamino, diisopropylamino or pyrrolidino,
R¹⁰³ is methyl or ethyl,
R¹⁰⁴ is methyl, ethyl or cyanoethyl or
NR¹⁰³R¹⁰⁴ is pyrrolidino or piperidino.

10. Process for preparing metal complexes according to claim 1, characterized in that a metal salt is reacted with an azo compound of the formula (Ib) 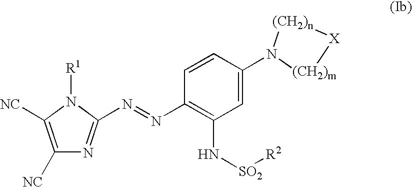
where
R¹ is hydrogen, substituted or unsubstituted C₁-C₆-alkyl or substituted or unsubstituted C₇-C₁₂-aralkyl,
R² is substituted or unsubstituted C₁-C₆-alkyl,
X is O, NH, NR³, CH₂ or a direct bond,
R³ is substituted or unsubstituted C₁-C₆-alkyl and
m and n are each, independently of one another, 1, 2 or 3,
or with an azo compound of the formula (LIb) 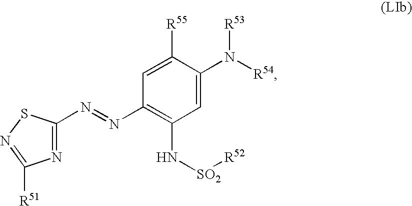
where
R⁵¹ is substituted or unsubstituted C₆-C₁₀-aryl, optionally phenyl, a substituted or unsubstituted 5- or 6-membered heterocyclic ring, optionally pyridyl, C₁-C₆-alkylthio, C₇-C₁₀-aralkylthio, substituted or unsubstituted C₆-C₁₀-arylthio, optionally phenylthio, C₁-C₆-alkylsulphonyl, C₇-C₁₀-aralkylsulphonyl or substituted unsubstituted C₆-C₁₀-arylsulphonyl, optionally phenylsulphonyl,
R⁵² is substituted or unsubstituted C₁-C₆-alkyl,
R⁵³ and R⁵⁴ are each, independently of one another, substituted or unsubstituted C₁-C₆-alkyl, substituted or unsubstituted C₇-C₁₀-aralkyl or substituted or unsubstituted C₆-C₁₀-aryl or
NR⁵³R⁵⁴ is pyrrolidino, piperidino, morpholino, piperazino or N—C₁-C₆-alkyl-piperidino,
R⁵⁵ is hydrogen, methyl or methoxy or
R⁵³, R⁵⁵ together form a —(CH₂)₂—, —(CH₂)₃— or —(CH₂)₂—O— bridge,
or with an azo compound of formula (CIb) 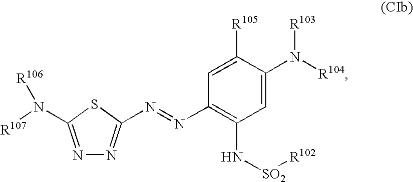
where
R¹⁰² is substituted or unsubstituted C₁-C₆-alkyl, in particular optionally C₁-C₆-alkyl or perfluoro-C₁-C₆-alkyl,
R¹⁰³, R¹⁰⁴, R¹⁰⁶ and R¹⁰⁷ are each, independently of one another, substituted or unsubstituted C₁-C₆-alkyl, substituted or unsubstituted C₇-C₁₀-aralkyl or substituted or unsubstituted C₆-C₁₀-aryl or
NR¹⁰³R¹⁰⁴ and NR¹⁰⁶R¹⁰⁷ are each, independently of one another, pyrrolidino, piperidino, morpholino, piperazino or N—C₁-C₆-alkyl-piperidino,
R¹⁰⁵ is hydrogen, methyl or methoxy or
R¹⁰³, R¹⁰⁵ together form a —(CH₂)₂—, —(CH₂)₃— or —(CH₂)₂—O— bridge.

11. Use of metal complexes according to claim 1 as light-absorbent compounds in the information layer of write-once optical data carriers.

12. Use according to claim 11, characterized in that the optical data carrier can be written on and read by means of blue laser light, optionally laser light having a wavelength in the range 360-460 nm.

13. Use according to claim 11, characterized in that the optical data carrier can be written on and read by means of red laser light, optionally laser light having a wavelength in the range 600-700 nm.

14. Use of metal complexes having azo ligands as light-absorbent compounds in the information layer of write-once optical data carriers which can be written on and read by means of blue laser light, optionally laser light having a wavelength in the range 360-460 nm.

15. Azo compounds of the formula (Ib) 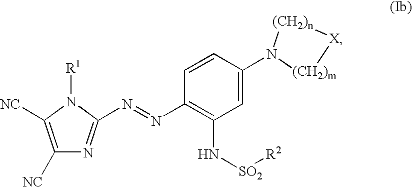
where
R¹ is hydrogen, substituted or unsubstituted C₁-C₆-alkyl or substituted or unsubstituted C₇-C₁₂-aralkyl,
R² is substituted or unsubstituted C₁-C₆-alkyl,
X is O, NH, NR³, CH₂ or a direct bond,
R³ is substituted or unsubstituted C₁-C₆-alkyl and
m and n are each, independently of one another, 1, 2 or 3,
or azo compounds of the formula (LIb) 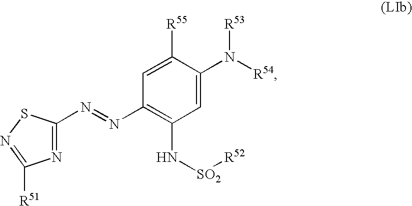
where
R⁵¹ is substituted or unsubstituted C₆-C₁₀-aryl, optionally phenyl, a substituted or unsubstituted 5- or 6-membered heterocyclic ring, optionally pyridyl, C₁-C₆-alkylthio, C₇-C₁₀-aralkylthio, substituted or unsubstituted C₆-C₁₀-arylthio, optionally phenylthio, C₁-C₆-alkylsulphonyl, C₇-C₁₀-aralkylsulphonyl or substituted or unsubstituted C₆-C₁₀-arylsulphonyl, optionally phenyl-sulphonyl,
R⁵² is substituted or unsubstituted C₁-C₆-alkyl, optionally C₁-C₆-alkyl or perfluoro-C₁-C₆-alkyl,
R⁵³ and R⁵⁴ are each, independently of one another, substituted or unsubstituted C₁-C₆-alkyl, substituted or unsubstituted C₇-C₁₀-aralkyl or substituted or unsubstituted C₆-C₁₀-aryl or
NR⁵³R⁵⁴ is pyrrolidino, piperidino, morpholino, piperazino or N—C₁-C₆-alkyl-piperidino,
R⁵⁵ is hydrogen, methyl or methoxy or
R⁵³, R⁵⁵ together form a —(CH₂)₂—, —(CH₂)₃— or —(CH₂)₂—O— bridge,
or azo compounds of formula (CIb) 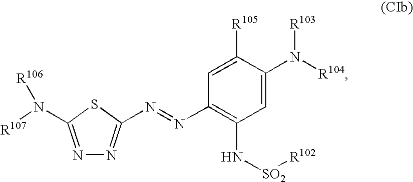
where
R¹⁰² is substituted or unsubstituted C₁-C₆-alkyl, optionally C₁-C₆-alkyl or perfluoro-C₁-C₆-alkyl,
R¹⁰³, R¹⁰⁴, R¹⁰⁶ and R¹⁰⁷ are each, independently of one another, substituted or unsubstituted C₁-C₆-alkyl, substituted or unsubstituted C₇-C₁₀-aralkyl or substituted or unsubstituted C₆-C₁₀-aryl or
NR¹⁰³R¹⁰⁴ and NR¹⁰⁶R¹⁰⁷ are each, independently of one another, pyrrolidino, piperidino, morpholino, piperazino or N—C₁-C₆-alkyl-piperidino,
R¹⁰⁵ is hydrogen, methyl or methoxy or
R¹⁰³, R¹⁰⁵ together form a —(CH₂)₂—, —(CH₂)₃— or —(CH₂)₂—O— bridge.

16. Azo compounds according to claim 15, characterized in that, in the formula (Ib)
R¹ is methyl, ethyl, propyl, butyl, cyanoethyl, methoxyethyl or benzyl,
R² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
X is O, CH₂ or a direct bond,
m and n are each, independently of one another, 1 or 2,
or in that, in the formula (LIb)
R⁵¹ is phenyl, pyridyl, methylthio, ethylthio, propylthio, benzylthio, methyl-sulphonyl, benzylsulphonyl or phenylsulphonyl,
R⁵² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl, preferably difluoromethyl, 3,3-difluoroethyl, 3,3,3-trifluoroethyl, trifluoromethyl, pentafluoroethyl, heptafluoropropyl or perfluorobutyl,
R⁵³ and R⁵⁴ are each, independently of one another, methyl, ethyl, propyl, butyl, cyanoethyl, chloroethyl, methoxyethyl, benzyl, phenethyl or phenyl or
NR⁵³R⁵⁴ is pyrrolidino, piperidino or morpholino,
R⁵⁵ is hydrogen,
where the propyl or butyl radicals may also be branched,
or in that, in the formula (CIb)
R¹⁰² is perfluoro-C₁-C₆-alkyl,
R¹⁰³, R¹⁰⁴, R¹⁰⁶ and R¹⁰⁷ are each, independently of one another, substituted or unsubstituted C₁-C₆-alkyl, substituted or unsubstituted C₇-C₁₀-aralkyl or substituted or unsubstituted C₆-C₁₀-aryl or
NR¹⁰³R¹⁰⁴ and NR¹⁰⁶R¹⁰⁷ are each, independently of one another, pyrrolidino, piperidino, morpholino, piperazino or N—C₁-C₆-alkyl-piperidino,
R¹⁰⁵ is hydrogen, methyl or methoxy or
R¹⁰³, R¹⁰⁵ together form a —(CH₂)₂—, —(CH₂)₃— or —(CH₂)₂—O— bridge.

17. Azo compounds according to claim 15 or 16, characterized in that, in the formula (Ib)
R¹ is methyl or ethyl,
R² is methyl or trifluoromethyl,
X is CH₂ or a direct bond,
m and n are each 2,
or in that, in the formula (LIb)
R⁵¹ is phenyl,
R⁵² is methyl or trifluoromethyl,
R⁵³ and R⁵⁴ are each, independently of one another, methyl, ethyl, cyanoethyl or benzyl or
NR⁵³R⁵⁴ is pyrrolidino or piperidino,
R⁵⁵ is hydrogen,
or in that, in the formula (CIb)
R¹⁰² is difluoromethyl, 3,3-difluoroethyl, 3,3,3-trifluoroethyl, trifluoromethyl, pentafluoroethyl, heptafluoropropyl or perfluorobutyl,
R¹⁰⁶ and R¹⁰⁷ are each, independently of one another, methyl, ethyl, propyl, butyl, cyanoethyl, chloroethyl, methoxyethyl, benzyl, phenethyl or phenyl or
NR¹⁰⁶R¹⁰⁷ is pyrrolidino, piperidino or morpholino,
R¹⁰³ and R¹⁰⁴ are each, independently of one another, methyl, ethyl, propyl, butyl, cyanoethyl, chloroethyl, methoxyethyl, benzyl, phenethyl or phenyl or
NR¹⁰³R¹⁰⁴ is pyrrolidino, piperidino or morpholino,
R¹⁰⁵ is hydrogen.

18. Azo compounds according to claim 15, characterized in that they correspond to the formula V, VI, LV or CV, 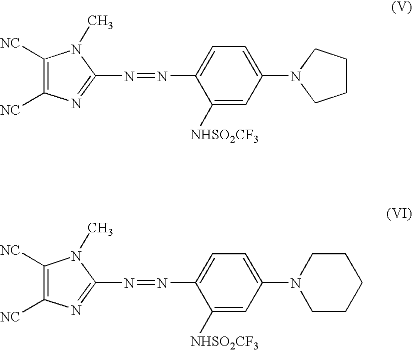 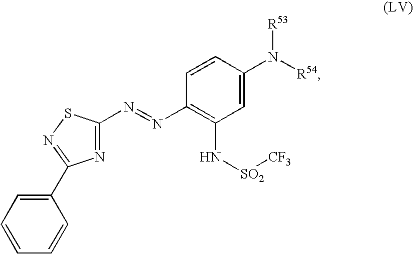
where
R⁵³ is methyl or ethyl,
R⁵⁴ is methyl, ethyl or cyanoethyl or
NR⁵³R⁵⁴ is pyrrolidino or piperidino, 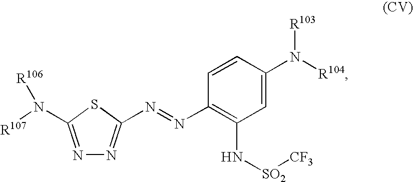
where
NR¹⁰⁶R¹⁰⁷ is dimethylamino, diisopropylamino or pyrrolidino,
R¹⁰³ is methyl or ethyl,
R¹⁰⁴ is methyl, ethyl or cyanoethyl or
NR¹⁰³R¹⁰⁴ is pyrrolidino or piperidino.

19. Process for preparing azo compounds of the formula (Ib) according to claim 15, characterized in that an aminoimidazole of the formula (VII) 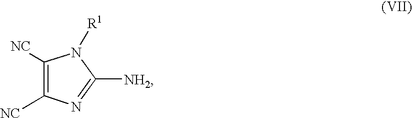
where
R¹ is hydrogen, substituted or unsubstituted C₁-C₆-alkyl or substituted or unsubstituted C₇-C₁₂-aralkyl,
is diazotized and
coupled with a coupling component of the formula VIII 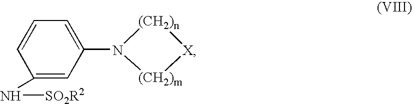
where
R² is substituted or unsubstituted C₁-C₆-alkyl,
X is O, NH, NR³, CH₂ or a direct bond,
R³ is substituted or unsubstituted C₁-C₆-alkyl and
m and n are each, independently of one another, 1, 2 or 3.

20. Process for preparing azo compounds of the formula (Ib) according to claim 15, characterized in that an aminoimidazole of the formula (IX) 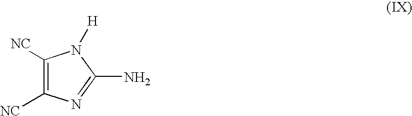
is diazotized, coupled with a coupling component of the formula VIII 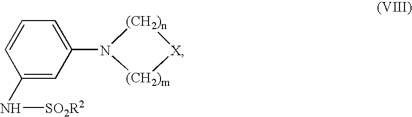
where
R² is substituted or unsubstituted C₁-C₆-alkyl,
X is O, NH, NR³, CH₂ or a direct bond,
R³ is substituted or unsubstituted C₁-C₆-alkyl and
m and n are each, independently of one another, 1, 2 or 3,
and subsequently reacted with an alkylating agent of the formula
R¹—Y (X),
where
R¹ is hydrogen, substituted or unsubstituted C₁-C₆-alkyl or substituted or unsubstituted C₇-C₁₂-aralkyl and
Y is a leaving group.

21. Process for preparing azo compounds of the formula (LIb) according to claim 15, characterized in that a 5-amino-1,2,4-thiadiazole of the formula (LVII) 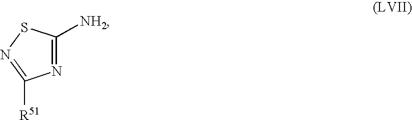
where
R⁵¹ is substituted or unsubstituted C₆-C₁₀-aryl, optionally phenyl, a substituted or unsubstituted 5- or 6-membered heterocyclic ring, in particular optionally pyridyl, substituted or unsubstituted C₁-C₆-alkylthio, substituted or unsubstituted C₇-C₁₀-aralkylthio or substituted or unsubstituted C₆-C₁₀-arylthio or phenylthio,
is diazotized or nitrosated and coupled with a coupling component of the formula LVIII 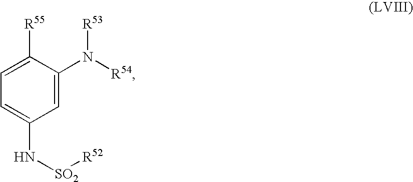
where
R⁵² is substituted or unsubstituted C₁-C₆-alkyl,
R⁵³ and R⁵⁴ are each, independently of one another, substituted or unsubstituted C₁-C₆-alkyl, substituted or unsubstituted C₇-C₁₀-aralkyl or substituted or unsubstituted C₆-C₁₀-aryl or
NR⁵³R⁵⁴ is pyrrolidino, piperidino, morpholino, piperazino or N—C₁-C₆-alkyl-piperidino,
R⁵⁵ is hydrogen, methyl or methoxy or
R⁵³, R⁵⁵ together form a —(CH₂)₂—, —(CH₂)₃— or —(CH₂)₂—O— bridge.

22. Process for preparing azo compounds of the formula (CIb) according to claim 15, characterized in that a 2-amino-1,3,4-thiadiazole the formula (CVII) 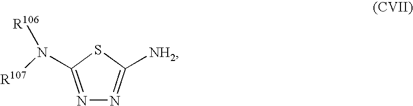
where
R¹⁰⁶ and R¹⁰⁷ are each, independently of one another, substituted or unsubstituted C₁-C₆-alkyl, substituted or unsubstituted C₇-C₁₀-aralkyl or substituted or unsubstituted C₆-C₁₀-aryl or
NR¹⁰⁶R¹⁰⁷ is pyrrolidino, piperidino, morpholino, piperazino or N—C₁-C₆-alkyl-piperidino,
is diazotized and coupled with a coupling component of the formula LVIII 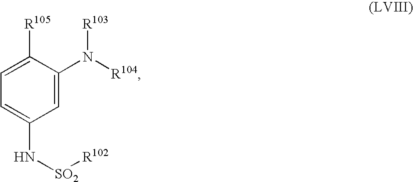
where
R¹⁰² is substituted or unsubstituted C₁-C₆-alkyl,
R¹⁰³ and R¹⁰⁴ are each, independently of one another, substituted or unsubstituted C₁-C₆-alkyl, substituted or unsubstituted C₇-C₁₀-aralkyl or substituted or unsubstituted C₆-C₁₀-aryl or
NR¹⁰³R¹⁰⁴ is pyrrolidino, piperidino, morpholino, piperazino or N—C₁-C₆-alkyl-piperidino,
R¹⁰⁵ is hydrogen, methyl or methoxy or
R¹⁰³, R¹⁰⁵ together form a —(CH₂)₂—, —(CH₂)₃— or —(CH₂)₂—O— bridge.

23. Compounds of the formula VIII 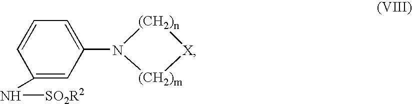
where
R² is substituted or unsubstituted C₁-C₆-alkyl,
X is O, NH, NR³, CH₂ or a direct bond,
R³ is substituted or unsubstituted C₁-C₆-alkyl and
m and n are each, independently of one another, 1, 2 or 3.

24. Process for preparing compounds of the formula VIII according to claim 23, characterized in that 3-nitroaniline is reacted with a bifunctional alkylating agent of the formula 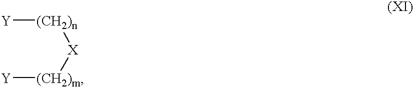
where
X is O, NH, NR³, CH₂ or a direct bond,
R³ is substituted or unsubstituted C₁-C₆-alkyl,
Y is a leaving group and
n and m are each, independently of one another, 1, 2 or 3,
to form a nitro compound of the formula 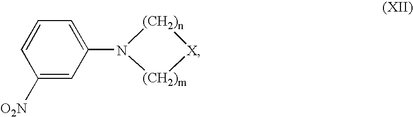
where
X is O, NH, NR³, CH₂ or a direct bond and
n and m are each, independently of one another, 1, 2 or 3,
the nitro compound of the formula (XII) is hydrogenated to form the amino compound of the formula 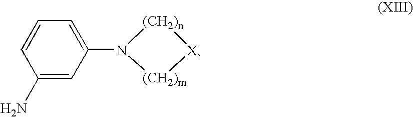
where
X is as defined above and
n and m are each, independently of one another, 1, 2 or 3,
and the amino compound of the formula (XIII) is reacted with an acid chloride or anhydride of the formula 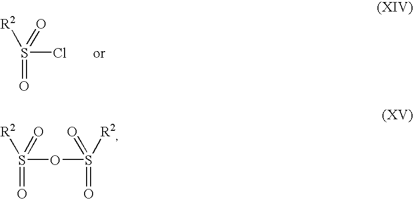
where
R² is substituted or unsubstituted C₁-C₆-alkyl.

25. Optical data carrier comprising a preferably transparent substrate which may, optionally, have previously been coated with one or more reflection layers and to whose surface a light-writable information layer, optionally one or more reflection layers and optionally a protective layer or a further substrate or a covering layer have been applied, which can be written on or read by means of blue or red light, optionally laser light, where the information layer comprises a light-absorbent compound and, optionally, a binder, characterized in that at least one metal complex according to claim 1 is used as light-absorbent compound.

26. Optical data carrier according to claim 25, characterized in that the light-absorbent compound has the formula (Ia)
[(I)]₂⁻M²⁺ (Ia)
where the formula I is as defined in claim 1 and M is a metal, or has the formula (LIa)
[(LI)]₂⁻M²⁺ (LIa)
where the two ligands of the formula (LIa) are each, independently of one another, as defined in claim 1 and
M is a metal,
or has the formula (CIa)
[(CI)]₂⁻M²⁺ (CIa)
where the two ligands of the formula (CI) are each, independently of one another, as defined in claim 1 and
M is a metal.

27. Optical data carrier according to claim 26, characterized in that the metal M is a divalent metal, transition metal or rare earth, optionally Mg, Ca, Sr, Ba, Cu, Ni, Co, Fe, Zn, Pd, Pt, Ru, Rh, Os or Sm.

28. Optical data carrier according to claim 25, characterized in that a metal complex having an azo ligand of the formula I in which
R¹ is methyl, ethyl, propyl, butyl, cyanoethyl, methoxyethyl or benzyl,
R² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
X is O, CH₂ or a direct bond,
m and n are each, independently of one another, 1 or 2 and
M is Pd, Fe, Zn, Cu, Ni or Co,
or has an azo ligand of the formula (LI) in which
R⁵¹ is phenyl, pyridyl, methylthio, ethylthio, propylthio, benzylthio, methylsulphonyl, benzylsulphonyl or phenylsulphonyl,
R⁵² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
R⁵³ and R⁵⁴ are each, independently of one another, methyl, ethyl, propyl, butyl, cyanoethyl, chloroethyl, methoxyethyl, benzyl, phenethyl or phenyl or
NR⁵³R⁵⁴ is pyrrolidino, piperidino or morpholino,
R⁵⁵ is hydrogen and
M is Pd, Fe, Zn, Cu, Ni or Co,
where the propyl or butyl radicals may also be branched,
or has an azo ligand of the formula (CI) in which
R¹⁰⁶ and R¹⁰⁷ are each, independently of one another, methyl, ethyl, propyl, butyl, cyanoethyl, chloroethyl, methoxyethyl, benzyl, phenethyl or phenyl or
NR¹⁰⁶R¹⁰⁷ is pyrrolidino, piperidino or morpholino,
R¹⁰² is methyl, ethyl, propyl, butyl, difluoromethyl, 3,3-difluoroethyl, 3,3,3-trifluoroethyl, trifluoromethyl, pentafluoroethyl, heptafluoropropyl or perfluorobutyl,
R¹⁰³ and R¹⁰⁴ are each, independently of one another, methyl, ethyl, propyl, butyl, cyanoethyl, chloroethyl, methoxyethyl, benzyl, phenethyl or phenyl or
NR¹⁰³R¹⁰⁴ is pyrrolidino, piperidino or morpholino,
R¹⁰⁵ is hydrogen and
M is Pd, Fe, Zn, Cu, Ni or Co,
where the propyl or butyl radicals may also be branched,
is used as light-absorbent compound.

29. Optical data carrier according to claim 25, characterized in that the metal complex has the formula III, IV, LIII or CIII 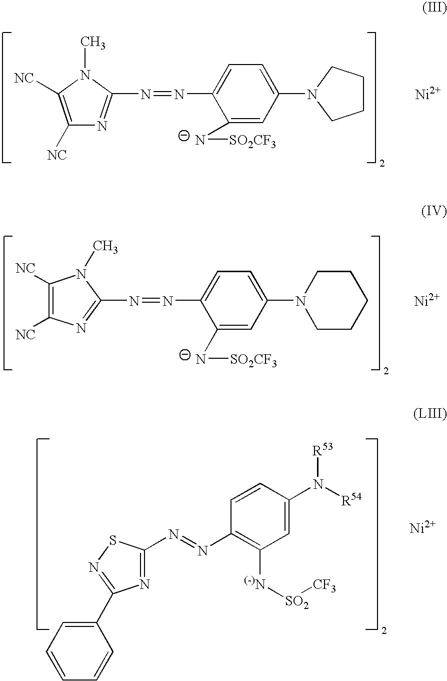
where
R⁵³ is methyl or ethyl,
R⁵⁴ is methyl, ethyl or cyanoethyl or
NR⁵³R⁵⁴ is pyrrolidino or piperidino, 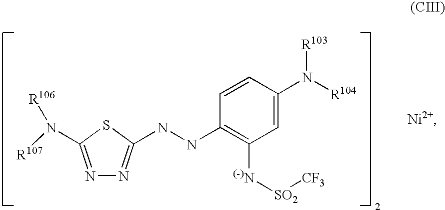
where
NR¹⁰⁶R¹⁰⁷ is dimethylamino, diisopropylamino or pyrrolidino,
R¹⁰³ is methyl or ethyl,
R¹⁰⁴ is methyl, ethyl or cyanoethyl or
NR¹⁰³R¹⁰⁴ is pyrrolidino or piperidino.

30. Process for producing an optical data carrier according to claim 25, which is characterized in that a preferably transparent substrate which may, optionally, have previously been coated with a reflection layer is coated with metal complexes according to claim 1, optionally in combination with suitable binders and additives and, optionally, suitable solvents, and is, optionally, provided with a reflection layer, further intermediate layers and optionally a protective layer or a further substrate or a covering layer.

31. Optical data carrier according to claim 25 which has been written on by means of blue red light, or optionally red laser light.
